(19) United States
(12) Patent Application Publication
(10) Pub. No.: US 2019/0073077 A1
(43) Pub. Date: Mar. 7, 2019

(54) PORTABLE TERMINAL INCLUDING TOUCH PRESSURE DETECTOR ON SIDE THEREOF

(71) Applicant: HiDeep Inc., Seongnam-si (KR)

(72) Inventors: Seyeob KIM, Seongnam-si (KR); Bonkee KIM, Seongnam-si (KR); Ho Jun MOON, Seongnam-si (KR)

(21) Appl. No.: 16/124,848

(22) Filed: Sep. 7, 2018

(30) Foreign Application Priority Data
Sep. 7, 2017 (KR) 10-2017-0114481

(51) Int. Cl. G06F 3/041; G06F 3/01

(52) U.S. Cl. CPC G06F 3/0414; G06F 3/016

(57) ABSTRACT

A portable terminal including a touch pressure detector on the side thereof may be provided that includes: at least one pressure detector which is formed on a side thereof and detects a touch pressure; and a control unit which controls to perform a function corresponding a predetermined condition, when the touch pressure detected by the at least one pressure detector satisfies the predetermined condition. According to the embodiment, the touch pressure detector which replaces a physical side operation key is mounted within a cover where each operation key is to be formed, so that a waterproofing performance and a dustproof performance of the terminal can be improved.

### CROSS REFERENCE TO RELATED APPLICATIONS

Priority is claimed under 35 U.S.C. § 119 to Korean Patent Application No. 10-2017-0114481, filed Sep. 7, 2017, the disclosure of which is incorporated herein by reference in its entirety.

### BACKGROUND

### Field

The present disclosure relates to a portable terminal including a touch pressure detector on the side thereof and more particularly to a portable terminal which detects a touch pressure by using a touch pressure detector formed in at least one area of the side thereof and performs functions corresponding thereto.

### Description of the Related Art

A portable terminal enables a user to communicate wirelessly with other parties while carrying it. The portable terminal is divided into a bar type, a flip type, a folder type, a slide type, a swing type, etc., in accordance with the appearance and motion type thereof.

This portable terminal has at least one physical side operation key on the side surface thereof in order to control the operation mode thereof, to power on/off, or to adjust various sound volumes.

Here, since the side operation key has to use a separate switch, the manufacturing cost increases and assemblability is degraded. Furthermore, the joint portion of the side operation key is not completely sealed, so that a waterproofing performance cannot be enhanced. In accordance with a recent trend in which the portable terminal is becoming thinner, many designs capable of reducing the area occupied by the side key without a front home button are proposed. However, the design for reducing the area of the physical side operation key has a limitation in making the portable terminal thinner.

### BRIEF SUMMARY

The object of the present invention is to provide a portable terminal which replaces a physical side operation key exposed to the outside by a touch pressure detector disposed in the inner mounting space of the side surface thereof.

One embodiment is a portable terminal may include: at least one pressure detector which is formed on a side thereof and detects a touch pressure; and a control unit which controls to perform a function corresponding a predetermined condition, when the touch pressure detected by the at least one pressure detector satisfies the predetermined condition.

The at least one pressure detector may be formed in a mounting space of a side portion which extends from a mid-frame or a back cover of the portable terminal or the at least one pressure detector may be formed on an inner surface of the side portion.

The portable terminal may further include a haptic module. The control unit may output a haptic feedback through the haptic module when the predetermined condition is satisfied.

The portable terminal may further include a touch detector which is disposed on or under the at least one pressure detector and detects whether the touch occurs or not and a touch input including a touch position.

When the control unit sets a function related to the at least one pressure detector to an inactive state and when the touch input is detected by the touch detector, the control unit may change the function related to the at least one pressure detector to an active state.

The portable terminal may further include a haptic module. The control unit may output a haptic feedback through the haptic module when the function related to the at least one pressure detector is changed to the active state.

When the control unit changes the function related to the at least one pressure detector to the active state and does not receive the touch input during a set period of time, the control unit may change the function related to the at least one pressure detector to the inactive state again.

When the control unit sets a function related to the touch detector to the inactive state and the touch pressure detected through the at least one pressure detector satisfies a predetermined condition, the control unit may change the function related to the touch detector to the active state.

The control unit may set the function corresponding to the predetermined condition by using at least one of a position at which the touch input is detected, a magnitude of the touch pressure, or a touch pressure pattern.

When the touch pressure is equal to or greater than a reference magnitude and a position where the touch input is detected is a first area among a plurality of side surface areas, the control unit may perform a function of turning on or off the power of the terminal.

When the touch pressure is equal to or greater than a reference magnitude and a position where the touch input is detected is a second area among a plurality of side surface areas, the control unit may perform a function of changing a mode of the terminal to a vibration mode or a normal mode.

When the touch pressure is equal to or greater than a reference magnitude and a position where the touch input is detected is a third area among a plurality of side surface areas, the control unit may adjust a sound volume in accordance with a pattern of the touch pressure.

The at least one pressure detector may further detect whether the touch occurs or not and a touch input including a touch position.

A top surface of the at least one pressure detector may be adhered to an inside of a side cover of the terminal.

The at least one pressure detector may detect the touch pressure by using at least one of a mutual capacitance, a self-capacitance, a strain gauge, a force sensing resistor, change of frequency, and change of thermal conductivity.

An indicator corresponding to each area where the at least one pressure detector has been formed may be displayed on the outside of the side portion of the terminal.

The at least one pressure detector may be composed of at least one of a pressure sensor formed as an electrode, a trace of a changing strain gauge, and a MEMS pressure sensor.

At least a portion of the side portion where the at least one pressure detector has been formed may be formed of a non-conductive material or is formed of a conductive material in a floating state.

### BRIEF DESCRIPTION OF THE DRAWINGS

FIG. 1 is a block diagram for describing the operation of a portable terminal according to an embodiment of the present invention;

FIGS. 2a and 2b are conceptual views of a conventional portable terminal viewed in different directions;

FIGS. 3a and 3b are conceptual views of the portable terminal according to the embodiment of the present invention viewed in different directions;

FIG. 4 is a view for describing the structure of the conventional portable terminal having a side operation key;

FIG. 5 is a view for describing the structure which has a side user input unit formed on a mid-frame in the portable terminal according to the embodiment of the present invention;

FIG. 6 is a view for describing the structure which has the side user input unit formed on a rear cover in the portable terminal according to the embodiment of the present invention;

FIG. 7 is a schematic flowchart showing a control method using a side touch pressure of the portable terminal according to the embodiment of the present invention;

FIG. 8 is a view for exemplarily describing the schematic structure of the side user input unit included in the portable terminal according to the embodiment of the present invention;

FIG. 9 is a view for exemplarily describing the schematic structure of the side user input unit included in the portable terminal according to the embodiment of the present invention;

FIGS. 10a to 10d are views for describing an exemplary operation principle of a pressure detector included in the portable terminal according to the embodiment of the present invention;

FIGS. 11a to 11i are views for describing the arrangement position and structure of the pressure detector included in the portable terminal according to the embodiment of the present invention;

FIGS. 12a to 12c are views for describing another arrangement position and structure of the pressure detector included in the portable terminal according to the embodiment of the present invention;

FIGS. 13a to 13c are views for describing further another arrangement position and structure of the pressure detector included in the portable terminal according to the embodiment of the present invention;

FIGS. 14a to 14f are views for describing yet another arrangement position and structure of the pressure detector included in the portable terminal according to the embodiment of the present invention;

FIGS. 15a to 15f are views for describing still another arrangement position and structure of the pressure detector included in the portable terminal according to the embodiment of the present invention;

FIGS. 16a to 16c are views showing that a pressure sensor according to the embodiment of the present invention is a strain gauge;

FIG. 17 shows a control block for controlling a touch position, a touch pressure, and the execution of functions corresponding thereto in the portable terminal according to the embodiment of the present invention;

FIGS. 18a to 18d are schematic views showing a capacitive touch detector included in the portable terminal according to the embodiment of the present invention, and the configuration for the operation of the same; and

FIG. 19 is a view for describing the structure of a side portion of the portable terminal according to the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Here, a portable terminal according to an exemplary embodiment of the present invention will be described with reference to the accompanying drawings. The portable terminal described in this specification may include a portable phone, a smart phone, a laptop computer, a terminal for digital broadcast, a personal digital assistant (PDA), a navigator, a slate PC, a tablet PC, an ultrabook, wearable devices, etc.

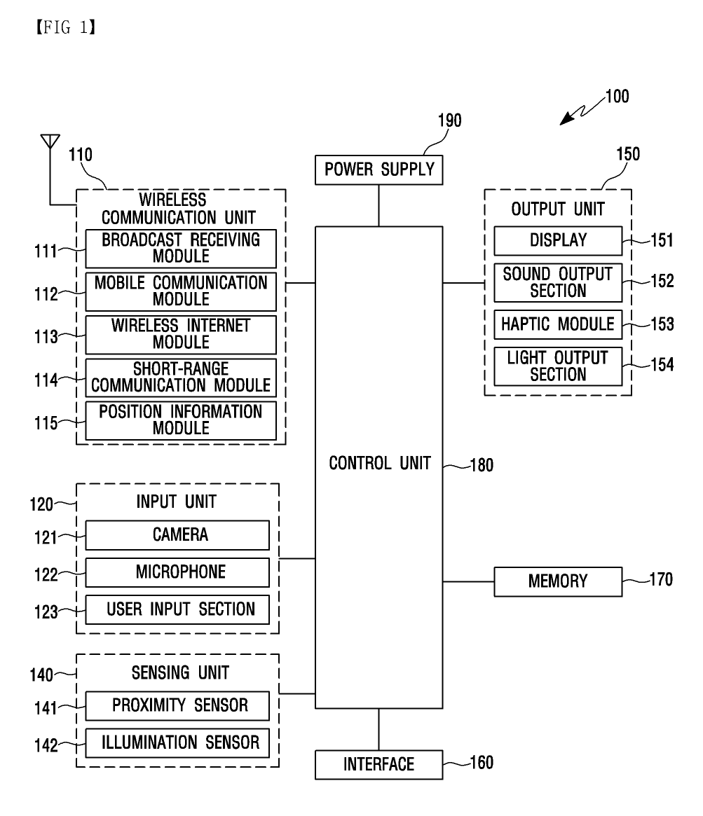

FIG. 1 is a block diagram for describing the operation of the portable terminal according to the embodiment of the present invention, and shows an example in which the present invention is applied to a smartphone.

Referring to FIG. 1, the portable terminal 100 may include a wireless communication unit 110, an input unit 120, a sensing unit 140, an output unit 150, an interface 160, a memory 170, a control unit 180, and a power supply 190. The components shown in FIG. 1 are not indispensable in the implementation of the portable terminal. The portable terminal described in the present specification may have a larger or smaller number of the components than that of the components described above.

The wireless communication unit 110 may include at least one module enabling wireless communication between the portable terminal 100 and a wireless communication system, between the portable terminal 100 and another portable terminal 100, or between the portable terminal 100 and an external server. The wireless communication unit 110 may include at least one module which connects the portable terminal 100 to at least one network. The wireless communication unit 110 may include at least one of a broadcast receiving module 111, a mobile communication module 112, a wireless internet module 113, a short-range communication module 114, and a position information module 115.

The broadcast receiving module 111 receives broadcast signals and/or broadcast related information through broadcast channels from an external broadcast management server. Here, the broadcast channel includes a satellite channel and a terrestrial channel. For the purpose of simultaneous broadcast reception or broadcast channel switching of at least two broadcast channels, two or more broadcast receiving modules may be included in the portable terminal 100.

The mobile communication module 112 transmits/receives a radio signal to and from at least one of a base station, an external terminal, and a server in a mobile communication network constructed in accordance with communication methods or technical standards for mobile communication. The wireless internet module 113 refers to a module for wireless internet access and may be built in or externally attached to the portable terminal 100.

The wireless internet module 113 transmits/receives a radio signal in a communication network based on wireless internet technologies such as Wireless LAN (WLAN), Wireless-Fidelity (Wi-Fi), etc.

The short-range communication module 114 supports short range communication by using Bluetooth™, Radio Frequency Identification (RFID), Infrared Data Association (IrDA), ZigBee, Near Field Communication (NFC), etc.

The position information module 115 obtains the position (or current position) of the device. A global positioning system (GPS) module or a wireless fidelity (Wi-Fi) module can be taken as a representative example of the position information module 115. However, the position information module 115 is not limited to a module for directly calculating or obtaining the position of the device.

The input unit 120 may include a video input section or a camera 121 for inputting a video signal, an audio input section or a microphone 122 for inputting an audio signal, and a user input section 123 (e.g., a touch key, a mechanical key, etc.) for receiving information of a user. The voice data or image data collected by the input unit 120 may be analyzed and processed as a control instruction of the user.

The camera 121 processes image frames of still images or videos, etc., obtained in a video call mode or in a photographing mode by an image sensor. The processed image frames may be displayed on a display 151 or may be stored in the memory 170.

The microphone 122 processes an external sound signal as an electrical voice data. The processed voice data can be variously used according to the function (or application program being executed) by the portable terminal 100.

The user input section 123 receives information from the user. When information is received through the user input section 123, the control unit 180 can control the operation of the portable terminal 100 in correspondence to the received information. The user input section 123 may include a mechanical input means (or a mechanical key, for example, a button disposed on the front, rear or side surface of the portable terminal 100, a dome switch, a jog wheel, a jog switch, etc.) and a touch-type input means. For example, the touch-type input means may include a virtual key, a soft key, or a visual key displayed on the touch screen through software processing, or may include a touch key disposed on a portion other than the touch screen. Here, the touch key may be formed on at least one area of the side surface of the portable terminal 100, for example, on a power key area or a volume key area, etc., or may be formed on at least one area of the side surface area which is equally divided into two or more areas, or may be formed on the entire side surface area of the terminal. Also, the touch key may include at least one of a touch sensor panel (TSP) for detecting whether or not a touch occurs and a touch position and a touch pressure detector for detecting a touch pressure. Hereinafter, the touch key formed on the side surface of the portable terminal 100 is referred to as a side user input unit.

The sensing unit 140 may include at least one sensor for sensing at least one of information on the inside of the device, information on ambient environment surrounding the device, and user information. For example, the sensing unit 140 may include a proximity sensor 141, an illumination sensor 142, a touch sensor, a touch pressure sensor, an acceleration sensor, a magnetic sensor, a G-sensor, a gyroscope sensor, a motion sensor, etc.

The output unit 150 generates an output related to a visual sense, an auditory sense, or a tactile sense, etc. The output unit 150 may include at least one of the display 151, a sound output section 152, a haptic module 153, and a light output section 154.

The display 151 may include, for example, a liquid crystal display (LCD), a thin film transistor-liquid crystal display (TFT LCD), an organic light-emitting diode (OLED), a flexible display, a 3D display, an e-ink display, etc. The display 151 can implement the touch screen by forming a mutual layer structure with the touch sensor or by being integrally formed with the touch sensor. The touch screen can function as the user input section 123 providing an input interface between the portable terminal 100 and the user and can provide an output interface between the portable terminal 100 and the user as well.

In order that the display 151 can receive a control command in a touch manner, the display 151 may include the touch sensor which senses a touch on the display 151. Through this, when a touch occurs on the display 151, the touch sensor senses the touch and the control unit 180 may generate a control command corresponding to the touch on the basis of the touch. The content input in a touch manner may be characters or numbers, instructions in various modes, or a menu item that can be designated. Meanwhile, the touch sensor may be formed in the form of a film having a touch pattern and may be disposed between a window and the display 151 on the back side of the window, or may be composed of a metal wire directly patterned on the back side of the window. According to the embodiment of the present invention, a control unit detecting whether or not the touch occurs and the touch position from the signal detected by the touch sensor may be provided in the display 151. In this case, the control unit transmits the detected touch position to the control unit 180. Alternatively, the display 151 transmits the signal detected by the touch sensor or a data obtained by converting the signal detected by the touch sensor into a digital data to the control unit 180. The control unit 180 can determine whether or not the touch has occurred and the touch position.

The sound output section 152 outputs audio signals such as music, voice, etc., and may include a receiver, a speaker, a buzzer, and the like. The haptic module 153 generates various tactile effects that the user can feel. A typical example of the tactile effect generated by the haptic module 153 may be vibration. The pattern, intensity, etc., of the vibration generated by the haptic module 153 can be controlled by user selection or by the setting of the control unit. For example, the haptic module 153 can synthesize mutually different vibrations and output or may sequentially output. The haptic module 153 can also produce not only vibration but also various tactile effects such as a pin arrangement moving perpendicular to contact skin surface, an air injection force or an air suction force through the injection portion or the suction portion, grazing the skin surface, electrode contact, effects due to stimulation such as an electrostatic force, etc., effect due to reproduction of cold and warm sensation using endothermic or exothermic elements, etc. The haptic module 153 can transmit the tactile effect through direct contact, and can allow a user to feel the tactile effect through muscular sense such as finger or arm. Two or more haptic modules 153 may be provided according to the aspect of the configuration of the portable terminal 100. The light output section 154 outputs a signal notifying the occurrence of an event by using the light of the light source of the portable terminal 100. An example of the event that occurs in the portable terminal 100 may include message reception, call signal reception, missed call, alarm, schedule notification, email reception, information reception through an application, etc.

The memory 170 stores data supporting various functions of the portable terminal 100. The memory 170 may store a plurality of application programs (or applications) executed by the portable terminal 100, data for operation of the portable terminal 100, and commands. At least some of these application programs may be downloaded from an external server via wireless communication. At least some of these application programs may exist in the portable terminal 100 from the time of release of the portable terminal 100 for the purpose of basic functions (e.g., call incoming and outgoing, message reception and transmission) of the portable terminal 100. Meanwhile, the application program is stored in the memory 170, installed in the portable terminal 100, and can be operated by the control unit 180 to perform the operation (or function) of the device.

The control unit 180 typically controls not only the operations related to the application programs, but also the overall operations of the portable terminal 100. The control unit 180 processes signals, data, information, etc., input or output through the above-described components, or executes the application programs stored in the memory 170, thereby providing appropriate information or functions to the user. In addition, the control unit 180 can control at least some of the components in order to execute the application programs stored in the memory 170. Further, the control unit 180 can operate the at least two components included in the portable terminal 100 in a combination thereof in order to execute the application programs.

The power supply 190 receives an electric power from external and internal power supplies under the control of the control unit 180, and supplies the electric power to each of the components included in the portable terminal 100. The power supply 190 may include a battery. The battery may be an embedded battery or a replaceable battery.

At least some of the respective components can operate in cooperation with each other in order to implement the operation, control or control method of the device according to various embodiments to be described below. Also, the operation, control or control method of the device can be implemented in the portable terminal by executing at least one application program stored in the memory 170.

The portable terminal 100 can distinguish the types of a touch command on the basis of a pressure. For example, the portable terminal 100 may recognize a touch input having a magnitude less than and not equal to a predetermined magnitude as a selection command for a touched area. Then, the portable terminal 100 can recognize a pressure touch having a magnitude greater than a predetermined magnitude as an additional command.

Hereinafter, several embodiments of the present invention will be described in detail with reference to the drawings. In the description below, the “pressure touch” means a touch having a pressure higher than a critical pressure. Here, the critical pressure can be appropriately set according to devices, fields of application, etc., to which the present invention is applied. For example, the critical pressure can be set as a pressure having a fixed magnitude. The magnitude can be appropriately set according to hardware characteristics, software characteristics, etc. Further, the user is also allowed to set the critical pressure.

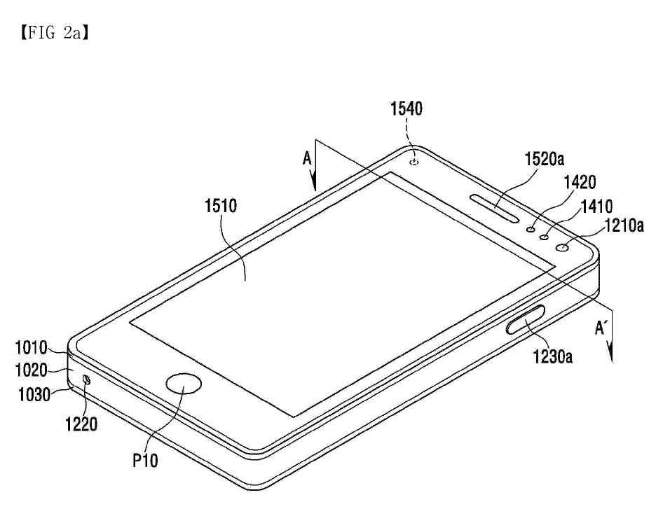

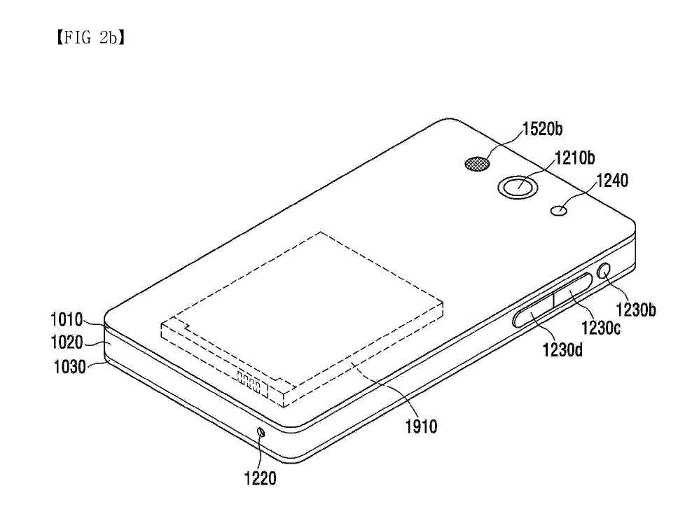

FIGS. 2a and 2b are conceptual views of a conventional portable terminal viewed in different directions. The conventional portable terminal includes a side operation key exposed outward from the side surface thereof.

Referring to FIGS. 2a and 2b, the portable terminal includes a bar-shaped terminal body, and can be also applied to various structures. Here, the portable terminal is regarded as at least one assembly and then the terminal body can be understood as a concept referring to it.

The portable terminal includes a case (for example, a frame, a housing, a cover, and the like) that forms an appearance thereof. As shown, the portable terminal may include a front case 1010 and a rear case 1020. Various electronic components are disposed in the inner space formed by the combination of the front case 1010 and the rear case 1020. At least one middle case may be further disposed between the front case 1010 and the rear case 1020, and the rear case 1020 includes a side cover. Hereinafter, the rear case 1020 is used as a concept including the side cover.

A display unit 1510 may be disposed on the front surface of the terminal body and output information. As shown, a window of the display unit 1510 may be mounted on the front case 1010 to form the front surface of the terminal body together with the front case 1010.

In some cases, electronic components may be mounted on the rear case 1020 as well. The electronic components that can be mounted on the rear case 1020 include an attachable and removable battery, an identification module, a memory card, etc. In this case, a rear cover 1030 for covering the mounted electronic components may be coupled to the rear case 1020 in an attachable and detachable manner. Therefore, when the rear cover 1030 is separated from the rear case 1020, the electronic components mounted on the rear case 1020 are exposed to the outside.

As shown, when the rear cover 1030 is coupled to the rear case 1020, a portion of the side surface of the rear case 1020 may be exposed. In some cases, the rear case 1020 may be completely covered by the rear cover 1030 when coupled. Meanwhile, the rear cover 1030 may be provided with an opening for exposing a camera 1210b or a sound output unit 1520b to the outside.

These cases 1010, 1020 and 1030 may be formed by injection-molding a synthetic resin or may be formed of a metal such as stainless steel (STS), aluminum (Al), titanium (Ti) or the like.

Unlike the above example in which the plurality of cases provide the inner space for receiving various electronic components, the portable terminal may be configured such that one case provides the inner space, In this case, a unibody portable terminal in which a synthetic resin or metal leads from the side to the rear can be implemented.

Meanwhile, the portable terminal may include a waterproof portion (not shown) for preventing water from penetrating into the terminal body. For example, the waterproof portion is provided between the window 1510a and the front case 1010, between the front case 1010 and the rear case 1020, or between the rear case 1020 and the rear cover 1030, and may include a waterproof member for sealing the inner space when they are coupled.

The portable terminal includes the display unit 1510, the first and second sound output units 1520a and 1520b, a proximity sensor 1410, an illumination sensor 1420, a light output unit 1540, the first and second cameras 1210a and 1210b, the first to fourth operation units 1230a to 1230d, a microphone 1220, an interface unit, etc. However, these configurations are not limited to this arrangement. These components may be omitted or replaced, or placed on different sides if necessary. For example, the second operation unit 1230b may not be provided on the side surface of the terminal body.

The first to fourth operation units 1230a to 1230d are an example of a user input unit 1230 (hereinafter, 1230a to 1230d are collectively defined as the user input unit 1230) which is operated to receive a command for controlling the operation of the portable terminal. The first to fourth operation units 1230a to 1230d can be collectively referred to as a manipulating portion. A physical button is pressed by a pressure, and thus, the first to fourth operation units 1230a to 1230d are switched to a connection portion formed within the rear case 1020 and transmit whether the operation unit is operated or not to the control unit. The first to fourth operation units 1230a to 1230d have a structure in which a dome key is formed under the physical key and the dome key is pressed by pressing the physical key, so that electrical connection is made. For example, one of the first to fourth operation units 1230a to 1230d may be used as a power key for performing a function of turning on or off the power of the terminal, and one of the first to fourth operation units 1230a to 1230d may be used as a mode conversion key of the terminal for switching the operation mode of the terminal to a vibration mode or a normal mode. Also, the remaining two operation units may be used as a sound volume adjustment key for adjusting the sound volume to be increased or decreased. Besides, the number of the operation units formed on the side surface and the assigned function can be variously changed.

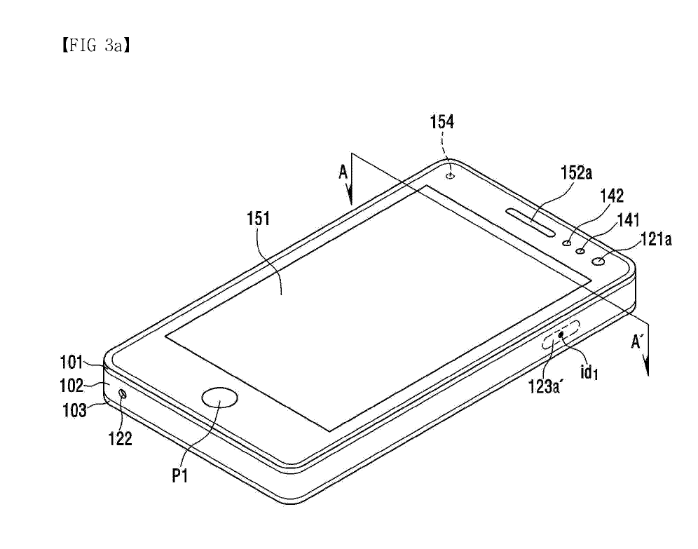

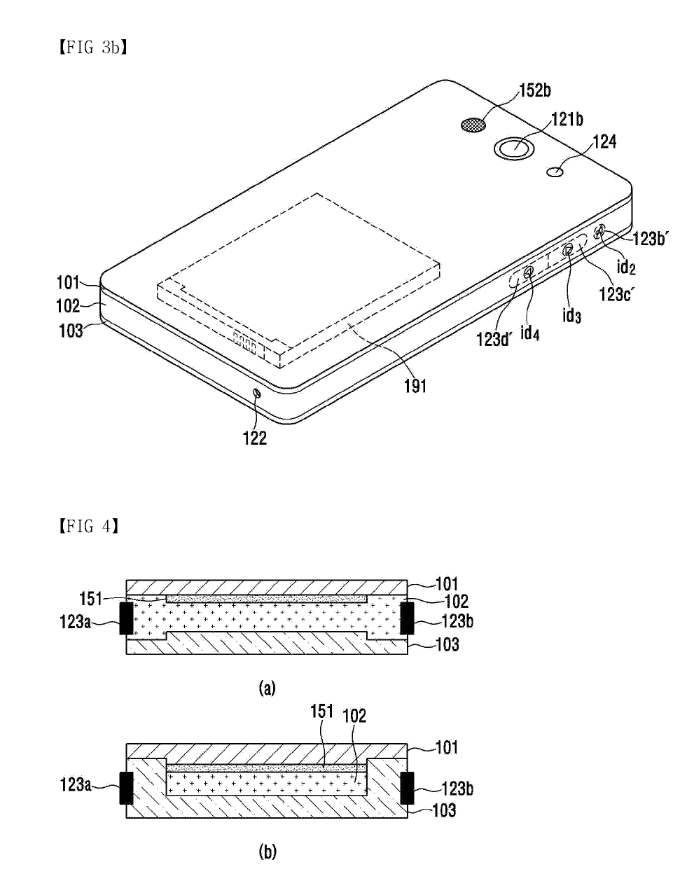

FIGS. 3a and 3b are conceptual views of the portable terminal according to the embodiment of the present invention viewed in different directions.

Referring to FIGS. 3a and 3b, the configurations and functions of the portable terminal 100 according to the embodiment of the present invention are similar to those of the typical portable terminal described above. However, the configuration and operation principle of the side user input unit corresponding to the first to fourth operation units are different from those of the typical portable terminal described above.

According to the embodiment of the present invention, the side user input units 123a′ to 123d′ of FIG. 3 which correspond to the first to fourth operation units 1230a to 1230d which are the side operation keys of the conventional portable terminal shown in FIG. 2 are formed within the body of the terminal, so that the side user input units 123a′ to 123d′ may not be physically exposed to the outside of the side cover of the terminal. The area indicated by the dotted line means a projected inside of the body of the terminal. Although four side user input units 123a′ to 123d′ are shown in FIGS. 3a and 3b, one or various numbers of the side user input units 123a′ to 123d′ may be formed, and the entire area of each side surface may be formed as the side user input unit. That is, the touch key may be formed only in an area (a power key area, a sound volume adjustment key area, etc.) that performs a specific function among the side of the terminal, or the touch key may be formed in at least one area among areas obtained by equally dividing the side surface of the terminal into a plurality of areas, or the touch key may be formed in the entire area of the side surface of the terminal. Here, the touch key may include at least one of a touch detector for detecting whether or not the touch occurs and the touch position and a pressure detector for detecting the touch pressure.

In addition, at least one indicator id1 to id4 indicating the position of the side user input units 123a′ to 123d′ may be further displayed on the outside of the side portion of the portable terminal 100 according to embodiment of the present invention. Here, the at least one indicator id1 to id4 may be represented by a character or a figure, or may be represented by engraving or embossing a specific pattern on the cover. Also, the at least one indicator id1 to id4 may be formed by LEDs inside the side portion. Here, the side portion may be a portion extending from the front case, a mid-frame or the rear cover to the side surface of the terminal or may be the side cover.

Hereinafter, an embodiment in which the side user input units 123a′ to 123d′ are formed within the body of the terminal through the cross-sectional view of the portable terminal 100 according to the embodiment of the present invention taken along line A-A′ will be described in detail.

The portable terminal may further include a side cover 104 surrounding the side surface of the terminal separately from the mid-frame 102.

FIGS. 4 to 6 are schematic cross-sectional views of the portable terminal taken along line A-A′, and show that some of the other components are omitted or shown in a simplified form in order to describe the structure of the side operation keys 123a and 123b or the side user input units 123a′ and 123b′.

FIG. 4 is a view for describing the structure of the conventional portable terminal having the side operation key and is a cross-sectional view of the conventional portable terminal shown in FIG. 2a taken along line A-A′.

Referring to (a) of FIG. 4a, the conventional portable terminal further includes an insertion portion (not shown) to which a portion of the side operation keys 123a and 123b exposed to the outside is inserted. The insertion portion is formed in at least one area of the side surface of the mid-frame 102. Thus, a portion of the side operation keys 123a and 123b may be connected to the mid-frame 102 of the terminal and the remaining portion of the side operation keys 123a and 123b may be exposed to the outside.

Referring to (b) of FIG. 4, the conventional portable terminal further includes an insertion portion (not shown) into which a portion of the side operation keys 123a and 123b exposed to the outside is inserted. The insertion portion is formed in at least one area of a portion where a rear cover 103 extends to the side surface of the terminal. Thus, a portion of the side operation keys 123a and 123b may be connected to the rear cover 103 of the terminal and the remaining portion of the side operation keys 123a and 123b may be exposed to the outside.

Regarding the conventional portable terminal, the side operation keys 123a and 123b exposed to the outside is pressed and connected to a conductor (e.g., Printed Circuit Board (PCB), FPCB or the like) formed in the mid-frame 102, so that electrical signals can be transmitted to the control unit. When it is determined that the side operation keys 123a and 123b are pressed, the control unit can control each component of the terminal to perform a function corresponding to each of the operation keys 123a and 123b. For example, after the power key 123a, the terminal mode control key 123b, etc., are physically formed on the side surface of the terminal, the power of the terminal may be turned on or off by pressing the power key 123a, or alternatively, the operation mode of the terminal may be switched to a vibration mode or a normal mode by pressing the terminal mode control key 123b. Here, the normal mode indicates one of a voice mode, a vibration mode, and a silent mode according to the operation mode of the terminal set by the user himself/herself.

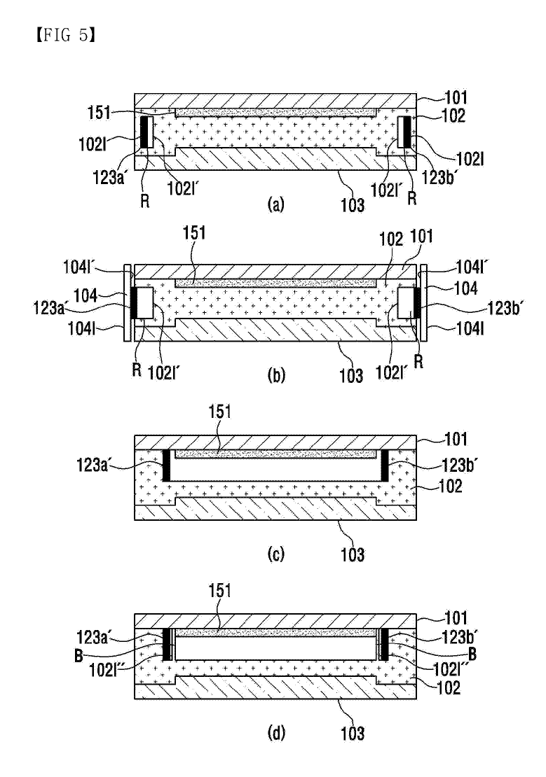

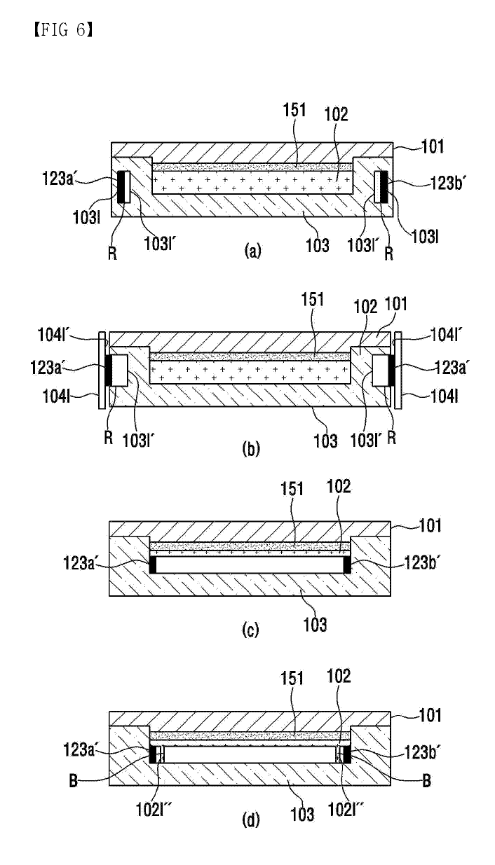

FIG. 5 is a view for describing the structure which has the side user input unit formed on the mid-frame in the portable terminal according to the embodiment of the present invention. FIG. 6 is a view for describing the structure which has the side user input unit formed on the rear cover in the portable terminal according to the embodiment of the present invention.

Schematically describing a section of the portable terminal according to the embodiment of the present invention, the portable terminal is formed by sequentially stacking the rear cover 103, the mid-frame 102, the display 151, and a front cover 101. A mounting space for the side user input unit may be further formed in the side surface or one area of the mid-frame 102 or the rear cover 103. Here, the mounting space may be formed within a portion where the mid-frame 102 or the rear cover 103 extends to the side surface, may be formed as a space where one side surface of the side portion of the mid-frame 102 is formed as an open space, may be formed as a partitioned space by the mid-frame 102 and a partition wall B, or may be formed as any space of the side surface of the cover. Here, any space of the side surface of the cover defines a space occupied by the pressure detector attached to the side surface of the cover.

Referring to (a) of FIG. 5a, in the portable terminal according to the embodiment of the present invention, an inner mounting space R may be formed in at least one area of the side portion of the mid-frame 102, and the side user input units 123a′ and 123b′ may be disposed in the inner mounting space R. The inner mounting space R of the side portion may be formed by forming the mid-frame as one mold and then cutting the space corresponding to the inner mounting space R of the side portion or may be formed such that the space corresponding to the inner mounting space R is not filled when the side portion of the mid-frame is formed. In addition, the inner mounting space R can be formed in various other ways.

At least one inner mounting space R of the mid-frame 102 may be formed in at least one area of the side portion, or one inner mounting space may be formed in entire one side surface, or the inner mounting space may be formed in entire both side surfaces. In addition, since the side user input units 123a′ and 123b′ are disposed in the inner mounting space R, the side user input units 123a′ and 123b′ are not exposed to the outside of the terminal.

The side user input units 123a′ and 123b′ include the pressure detector, and the pressure detector is disposed in parallel with the side surface of the terminal. Therefore, the side user input units 123a′ and 123b′ can adhere to a first side surface 1021 of the mounting space R of the mid-frame 102 or a second side surface 1021′ facing the first side surface 1021.

Referring to (b) of FIG. 5, in the portable terminal according to the embodiment of the present invention, the concave mounting space R having one open side is formed in at least one area of the side portion of the mid-frame 102, and the side user input units 123a′ and 123b′ may be disposed in the mounting space R. Also, when the side cover 104 is coupled to the side surface of the terminal in such a manner as to cover the one open side of the mounting space R, the concave mounting space R is not exposed to the outside.

At least one side mounting space R of the mid-frame 102 may be formed in at least one area of the side surface of the mid-frame 102, or the side mounting space R of the mid-frame 102 may be formed in entire one side surface or entire both side surfaces. When the side user input units 123a′ and 123b′ are disposed within the mounting space R and then the side cover 104 is coupled, the side user input units 123a′ and 123b′ are not exposed to the outside of the terminal.

The side user input units 123a′ and 123b′ include the pressure detector, and the pressure detector is disposed in parallel with the side surface of the terminal. Therefore, the side user input units 123a′ and 123b′ can adhere to an inner surface 1041′ of the side cover 104 or the second side surface 1021′ of the mounting space R.

Referring to (c) of FIG. 5, the portable terminal according to the embodiment of the present invention may include the side user input units 123a′ and 123b′ formed on the inner surface of the side portion. The inner surface of the side portion is not exposed to the outside. In this case, the display 151 may be disposed apart from the inner surface of the side portion by a predetermined distance.

Referring to (d) of FIG. 5, the portable terminal according to the embodiment of the present invention may further include the partition wall B spaced apart from the inner wall of the side portion by a predetermined distance. The side user input units 123a′ and 123b′ may be disposed in the mounting space R between the inner surface of the side portion and the partition wall B. Although the partition wall B is shown as being formed integrally with the mid-frame 102, the partition wall B may be formed in the form of the partition wall B separated from the mid-frame 102.

The side user input units 123a′ and 123b′ may be attached to the inner wall of the side portion or to the partition wall B in parallel with the side surface, and are not exposed to the outside of the side portion.

The side user input units 123a′ and 123b′ according to the embodiment of the present invention may include at least one pressure detector. When at least one pressure detector formed in the mounting space R of the side portion detects the touch pressure by using a capacitance, the first side surface 1021 and the second side surface 1021′ of the inner mounting space R of the side portion, the inner surface 1041′ of the side cover 104, an outer surface 1041 of the side cover 104, an inner wall (not shown) of the mid-frame 102, or one surface 1021″ of the partition wall B may be a reference potential layer. In addition, a separate reference potential layer may be further formed within the pressure detector.

FIG. 6 shows an embodiment in which the rear cover 103 extends to the side surface and forms the side portion, only the structures of the mid-frame 102 and the rear cover 103 are different, and the other components are the same.

Referring to (a) of FIG. 6, the portable terminal according to the embodiment of the present invention may include at least one inner mounting space R formed in at least one area of the side portion where the rear cover 103 extends to the side surface. In addition, the side user input units 123a′ and 123b′ may be disposed in the inner mounting space R.

At least one inner mounting space R of the rear cover 103 may be formed in at least one area of the side surface of the rear cover 103, or the inner mounting space R of the rear cover 103 may be formed in entire one side surface or entire both side surfaces. Since the side user input units 123a′ and 123b′ are disposed in the inner mounting space R of the rear cover 103, the side user input units 123a′ and 123b′ are not exposed to the outside of the terminal. The inner mounting space R of the side portion can be formed in various ways as described above in accordance with the position and structure of the mounting space.

The side user input units 123a′ and 123b′ include the pressure detector, and the pressure detector is disposed in parallel with the side surface of the terminal. Therefore, the side user input units 123a′ and 123b′ can adhere to a first side surface 1031 of the mounting space R of the rear cover 103 or a second side surface 1031′ facing the first side surface 1031.

Referring to (b) of FIG. 6, in the portable terminal according to the embodiment of the present invention, the concave mounting space R is formed in at least one area of the side portion of the rear cover 103. Here, when the side cover 104 is coupled to the side surface of the terminal, the concave mounting space R is not exposed to the outside.

At least one side mounting space R of the rear cover 103 is formed in at least one separate area of a portion where the rear cover 103 extends to the side surface of the terminal. The side mounting space R may be formed in entire one side surface or entire both side surfaces. Also, when the side user input units 123a′ and 123b′ are disposed in the mounting space R and then the side cover 104 is coupled, the side user input units 123a′ and 123b′ are not exposed to the outside of the terminal.

The side user input units 123a′ and 123b′ include the pressure detector, and the pressure detector is disposed in parallel with the side surface of the terminal. Therefore, the side user input units 123a′ and 123b′ can adhere to an inner surface 1041′ of the side cover 104 or the second side surface 1031′ of the mounting space R.

Referring to (c) of FIG. 6, the portable terminal according to the embodiment of the present invention may include the side user input units 123a′ and 123b′ formed on the inner wall of the side portion of the rear cover 103. The inner wall of the side portion is not exposed to the outside. The side user input units 123a′ and 123b′ may be disposed on the inner wall of the side portion in a direction perpendicular to the bottom surface of the mid-frame 102 and the bottom surface of the rear cover 103 and in a direction parallel to the side surface.

Referring to (d) of FIG. 6, the portable terminal according to the embodiment of the present invention may further include the partition wall B spaced apart from the inner wall of the side portion by a predetermined distance. The side user input units 123a′ and 123b′ may be disposed in the mounting space R between the inner surface of the side portion and the partition wall B. Although the partition wall B is shown as being formed integrally with the mid-frame 102, the partition wall B may be formed in the form of the partition wall B separated from the mid-frame 102 or may be formed integrally with the rear cover 103.

The side user input units 123a′ and 123b′ may be attached to the inner wall (surface facing the partition wall B) of the side portion of the rear cover 103 or to one surface 1021″ of the partition wall B in parallel with the side surface, and are not exposed to the outside of the side portion.

The side user input units 123a′ and 123b′ may include at least one pressure detector. When at least one pressure detector formed in the mounting space R of the side portion detects the touch pressure by using a capacitance, the first side surface 1031 and the second side surface 1031′ of the inner mounting space R of the side portion, the inner surface 1041′ of the side cover 104, the outer surface 1041 of the side cover 104, the inner wall (not shown) of the rear cover 103 or the one surface 1021″ of the partition wall B may be a reference potential layer. In addition, a separate reference potential layer may be further formed within the pressure detector.

FIGS. 5 to 6 show that the side user input unit is formed as the touch key on the side portion of the mid-frame 102 or the side portion of the rear cover 103. However, when the front cover 101 extends to the side surface, the touch key may be formed on the side portion of the front cover and can be applied similarly to the case where the touch key is formed on the side portion of the rear cover 103.

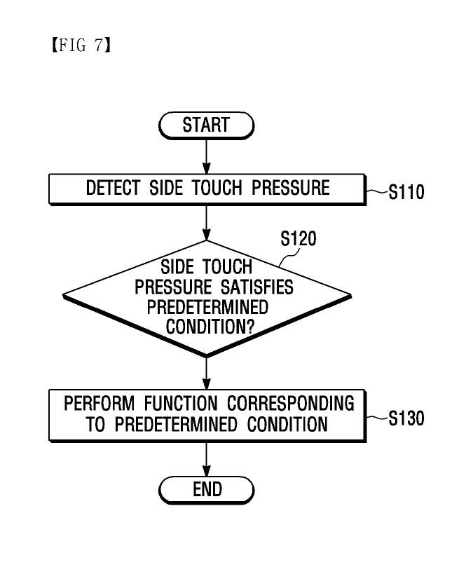

FIG. 7 is a schematic flowchart showing a control method using a side touch pressure of the portable terminal according to the embodiment of the present invention.

Referring to FIG. 7, in the control method using the side touch pressure of the portable terminal according to the embodiment of the present invention, the side touch pressure is detected (S110), and it is determined whether the detected side touch pressure satisfies a predetermined condition (S120). As a result of the determination, if the side touch pressure satisfies the predetermined condition, a function corresponding to the predetermined condition can be performed (S130).

Specifically, the portable terminal according to the embodiment of the present invention may include at least one pressure detector 400 formed in the inner mounting space of the terminal and the control unit. At least one pressure detector 400 can detect the touch pressure applied perpendicular to the side surface of the terminal. When the touch pressure detected through at least one pressure detector 400 formed on the side surface of the terminal satisfies a predetermined condition, the control unit can control to perform a function corresponding to the predetermined condition.

The control unit can set a function corresponding to a predetermined condition by using at least one of a position at which the touch input is detected, the magnitude of the touch pressure, or a touch pressure pattern. That is, the predetermined condition and the function corresponding to the predetermined condition can be set in various ways by considering whether the position where the touch input is detected corresponds to a power key area, a terminal mode conversion key area, or a sound volume adjustment key area, a magnitude level of the touch pressure, touch pressure patterns, etc. The control unit provides a user interface for setting the function corresponding to the predetermined condition, and can set the function and change the setting in accordance with the input of the user.

Specifically, when the touch pressure is equal to or greater than a reference magnitude and the position where the touch input is detected is the power key area, the control unit can perform a function of turning on or off the power of the terminal. When the touch pressure is equal to or greater than the reference magnitude and the position where the touch input is detected is the terminal mode conversion key area, the control unit can perform a function of changing the mode of the terminal to the vibration mode or the normal mode. When the touch pressure is equal to or greater than the reference magnitude and the position where the touch input is detected is the sound volume adjustment key area, the control unit can adjust the sound volume in accordance with the touch pressure pattern. In addition to the above-described embodiments, the control unit can set various functions corresponding to the touch pressure on each pressure detector. For example, when the control unit receives a pressure touch on a first side surface user input unit (first pressure detector) of the first side surface of the terminal, the sound volume can be set to increase. When the control unit receives a pressure touch on a second side surface user input unit (second pressure detector) of the second side surface of the terminal, the sound volume can be set to decrease. Here, the size of the volume can be set to be gradually increased or decreased by the control unit in accordance with the number of pressure touches or the magnitude of the pressure touch on the pressure detector of each side surface. In addition, various functions can be set to be performed by the control unit in consideration of the touch position, the pressure touch magnitude, the number of touches, the touch pattern, and the like. The control unit can provide a user interface for the pressure touch on the side user input unit and for setting the function of the terminal.

The control unit may output a haptic feedback through the haptic module when the predetermined condition is satisfied. Also, when the control unit sets a function related to at least one pressure detector to an inactive state and when the touch input is detected by the touch detector, the control unit can change the function related to at least one pressure detector to an active state. When the function related to at least one pressure detector is set to the active state, the control unit can output the haptic feedback through the haptic module. When the control unit changes the function related to at least one pressure detector to the active state and does not receive the touch input during a set period of time, the control unit can change the function related to at least one pressure detector to the inactive state again.

Also, when the control unit sets a function related to the touch detector to the inactive state and the touch pressure detected through at least one pressure detector satisfies a predetermined condition, the control unit can change the function related to the touch detector to the active state. Here, the touch pressure means a touch having a pressure magnitude equal to or greater than a reference pressure.

In the above configuration, for the purpose of distinguishing between a typical gesture for applying the touch pressure and the touch pressure on the side user input unit when the user holds the terminal, after the control unit sets the function related to at least one pressure detector to the inactive state by default, only when the control unit detects the touch input to the area where at least one pressure detector is formed, the control unit recognizes the touch input as the operation of the side user input unit and sets the function corresponding to at least one pressure detector to be activated. In addition, in order that the user can recognize the function activation of the side user input unit, the control unit outputs the haptic feedback and thus prevent malfunction.

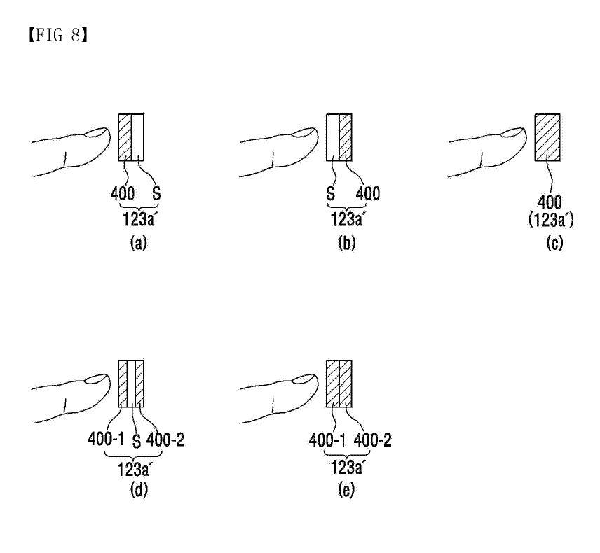

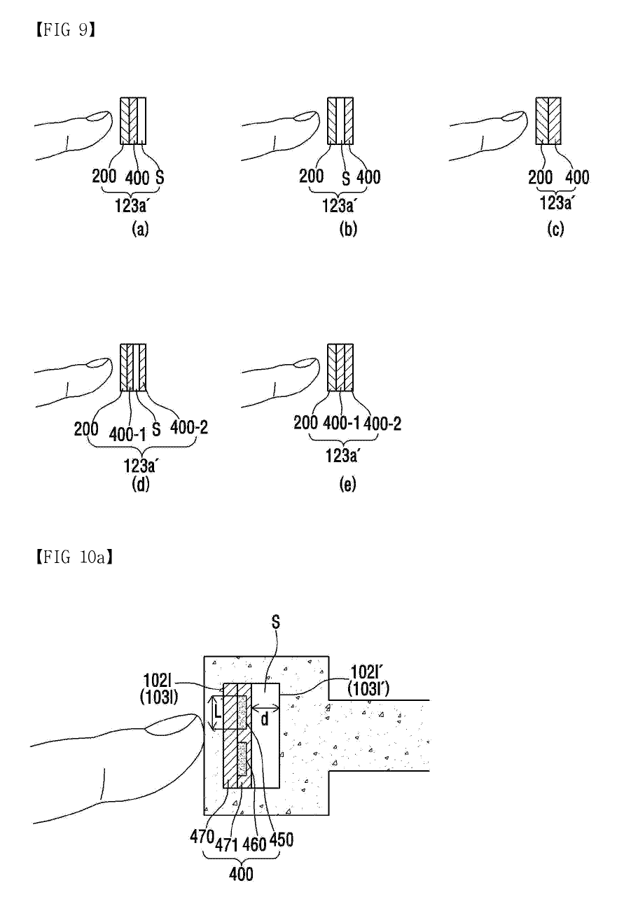

FIGS. 8 to 9 are views for illustratively describing a structure of the side user input unit included in the portable terminal according to the embodiment of the present invention.

As described in FIGS. 5 to 6, the side user input unit 123a′ may be formed on at least one side surface of the side portion inner mounting portion R of the mid-frame 102 or the rear cover 103, on the inner wall of the side portion, or on the partition wall B facing the inner wall of the side portion.

Referring to FIG. 8, the side user input unit 123a′ included in the portable terminal according to the embodiment of the present invention may include at least one pressure detector 400. A predetermined space S may be formed such that a distance between the pressure detector and the reference potential layer can be changed by the touch pressure applied perpendicular to the side surface of the terminal. The predetermined space may be variously formed such as an adhesive layer, a spacer layer, an air gap, an elastic foam, etc., and may have a width of several tens of micrometers.

The side user input unit 123a′ may be composed of one pressure detector 400 to form the predetermined space S (see (a) and (b) of FIG. 8), may be composed of one pressure detector 400 including the predetermined space S therein (see (c) of FIG. 8), may be composed of two pressure detectors 400-1 and 400-2 with the predetermined space S placed therebetween (see (d) of FIG. 8), or may be composed of two pressure detectors 400-1 and 400-2, at least one of which includes the predetermined space S therein (see (e) of FIG. 8).

At least one pressure detector 400 may be, as described in FIGS. 5 to 6, disposed in the inner mounting space of the side portion of the terminal, on the inner surface of the side portion, or on the partition wall B facing the inner surface, such that the top surface of the pressure detector is parallel with the side surface of the terminal. Also, the side cover may be further formed on the pressure detector 400. At least one pressure detector 400 measures a physical quantity representing the magnitude of an interaction force between two objects and determines the magnitude of the pressure by detecting capacitance change due to the change of the force, displacement of material, deformation, change of frequency, change of thermal conductivity, etc. The pressure sensor can be fabricated as an ultra-small and low-power sensor by using a semiconductor device fabrication technology and Micro Electro Mechanical System (MEMS) technology. The pressure sensor may be divided according to a pressure detection method into a piezoresistive type using electrical resistance change and a capacitive type using the capacitance change. The pressure sensor using the piezoresistive type may include a MEMS pressure sensor, a strain gauge or a force sensing resistor, and the pressure sensor using the capacitive type may include at least one pressure electrode. At least one pressure detector 400 may further detect whether the touch occurs or not and the touch input including the touch position. That is, at least one pressure detector 400 may be formed to have a structure capable of detecting only the pressure touch or may be formed to have a structure capable of performing the function of the touch detector capable of detecting not only the pressure touch but also whether or not the touch of the touch input of which the touch pressure is less than a critical pressure occurs and the touch position. At least one pressure detector 400 may be adhered to one of one side surface, the inner wall, and the partition wall B facing the inner wall in the mounting space R of FIGS. 5 to 6, so that another can move freely by the pressure touch.

Specifically, when at least one pressure detector 400 is formed in the form of a sheet, a first and a second pressure detector sheet 400-1 and 400-2 may be disposed such that a predetermined space S is formed within the first and second pressure detector sheets 400-1 and 400-2 or between the first pressure detector sheet 400-1 and the second pressure detector sheet 400-2. Also, when at least one pressure detector 400 is formed in the form of a sheet and an elastic foam is formed on one of the first and second pressure detector sheets 400-1 and 400-2, the first and second pressure detector sheets 400-1 and 400-2 can be disposed without forming the predetermined space S between the first pressure detector sheet 400-1 and the second pressure detector sheet 400-2.

Referring to FIG. 9, the side user input unit 123a′ included in the portable terminal according to the embodiment of the present invention may further include a touch detector 200. That is, the side user input unit 123a′ may include at least one pressure detector 400 and the touch detector 200 for detecting whether the touch occurs or not and detecting the touch input including the touch position.

In this case, at least one pressure detector 400 detects only the pressure touch, the touch detector 200 can detect even a touch input which is not the pressure touch and can also detect the touch position. The touch detector 200 may be formed only on an area where at least one pressure detector 400 is formed or may be formed integrally with the entire side area of the terminal, which includes the area where at least one pressure detector 400 is formed. The touch detector 200 and at least one pressure detector 400 may be disposed in parallel with the side surface of the terminal such that the touch input or the touch pressure is applied in the vertical direction.

When the touch detector 200 is formed on the top surface of at least one pressure detector 400, the top surface of the touch detector 200 may be adhered to the inside of the side cover of the terminal. Contrary to this, when the touch detector 200 is formed on the bottom surface of at least one pressure detector 400, the top surface of at least one pressure detector 400 may be adhered to the inside of the side cover of the terminal. Preferably, the touch detector 200 may be formed on the top surface of the pressure detector 400. The touch detector 200 may be disposed on the surface of the terminal or may be adhered to the mounting space close to the surface so that a capacitance change can be detected not only when an object such as a finger, a stylus, etc., touches the terminal, but also when the object approaches close to the terminal.

Specifically, in order that the touch detector 200, the pressure detector 400, and the predetermined space S are sequentially positioned, the touch detector 200 and the pressure detector 400 may be adhered to each other and one surface of the touch detector 200 which has not adhered to the pressure detector 400 may be attached to the side surface of the terminal (see (a) of FIG. 9). Here, the predetermined space S may be an air gap.

Also, in order that the touch detector 200, the predetermined space S, and the pressure detector 400 are sequentially positioned, the touch detector 200 may be attached to the first side surface of the mounting space of the terminal and the pressure detector 400 may be attached to the second side surface of the mounting space of the terminal. Here, the predetermined space S may be an air gap (see (b) of FIG. 9). Also, when the predetermined space S is formed of a material such as an elastic foam, an adhesive layer, etc., the touch detector 200, the predetermined space S, and the pressure detector 400 are integrally formed, and then one surface of the touch detector 200 or the pressure detector 400 may be attached to one surface of the side portion mounting space of the terminal. Here, the surface to which the touch detector 200 or the pressure detector 400 is attached has been described in detail with reference to FIGS. 5 to 6.

When the predetermined space S is included within the pressure detector 400, for example, when the elastic foam is disposed within the pressure detector, the width of the mounting space R may be determined such that the touch detector 200 and the pressure detector 400 are mounted within the side portion mounting space R of the terminal (see (c) of FIG. 9).

When the pressure detector 400 is formed in the form of a sheet, the first and second pressure detector sheets 400-1 and 400-2 may be disposed such that the predetermined space S is formed between the first and second pressure detector sheets 400-1 and 400-2, and the touch detector 200 may be disposed on the first pressure detector sheet 400-1. Here, the touch detector 200 may be disposed on the first side surface (1021 and 1031 of FIGS. 5 to 6) of the mounting space (R of FIGS. 5 to 6) (see (d) of FIG. 9).

When the pressure detector 400 is formed in the form of a sheet and the elastic foam is formed on one of the first and second pressure detector sheets 400-1 and 400-2, there is no need to form a separate space between the first and second pressure detector sheets 400-1 and 400-2, and the touch detector 200 may be disposed on the first side surface (1021 and 1031 of FIGS. 5 to 6) of the mounting space (R of FIGS. 5 to 6) of the side portion of the terminal, and subsequently the first and second pressure detector sheets 400-1 and 400-2 may be disposed, and thus, the second pressure detector sheet 400-2 may be disposed on the second side surface (1021′ and 1031′ of FIGS. 5 to 6) (see (e) of FIG. 9).

Hereinafter, the configuration for pressure detection will be collectively referred to as the pressure detector. For example, in the embodiment, the pressure detector may include pressure sensors 450 and 460.

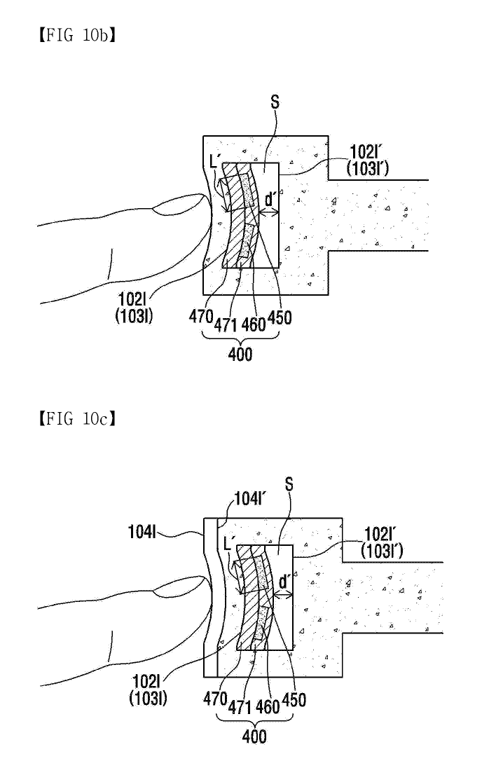

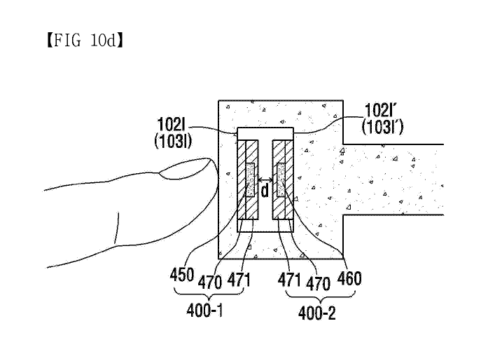

FIGS. 10a to 10d are views for describing an exemplary operation principle of the pressure detector included in the portable terminal according to the embodiment of the present invention.

Referring to FIGS. 10a to 10d, one side of the pressure detector 400 included in the portable terminal according to the embodiment of the present invention may be adhered to at least one of the first side surface 1021 and 1031 and the second side surface 1021′ and 1031′ of the mounting space R.

Hereinafter, a case where the first and second pressure sensors 450 and 460 are formed as electrodes when the touch pressure is detected by using a capacitance change amount will be described by an example.

Referring to FIG. 10a, in the pressure detector 400, since a second insulation layer 471 is positioned after the first and second pressure sensors 450 and 460 are formed on a first insulation layer 470, the first and second pressure sensors 450 and 460 can be prevented from being short-circuited with the mid-frame 102 or the rear cover 103. The mounting space may be formed to maintain, together with the pressure detector 400, the predetermined space S is maintained. Here, the predetermined space S may be formed in various forms such as an air gap, a spacer layer, an elastic foam, and an adhesive layer, and may have a width of several micrometers. One of the first pressure sensor 450 and the second pressure sensor 460 may be a drive electrode and the other may be a receiving electrode. As a drive signal is applied to the drive electrode and the pressure is applied, electrical characteristics changing through the receiving electrode can be sensed. Here, the reference potential layer (or also referred to as a ground potential layer) may be the first side surface 1021 and 1031 or the second side surface 1021′ and 1031′ of the mounting space. For example, mutual capacitance may be generated between the first pressure sensor 450 and the second pressure sensor 460.

Referring to FIGS. 10b and 10c, when the pressure is applied to the side surface of the terminal through the object in the vertical direction, the pressure detector 400 disposed in the mounting space and the side frame 102, the rear cover 103 or the side cover 104 are bent so that a distance d between the pressure detector 400 and the reference potential layer may be reduced to d′. In this case, as the distance decreases, fringing capacitance is absorbed in the side surface of the terminal, so that the mutual capacitance between the first pressure sensor 450 and the second pressure sensor 460 may be reduced. Therefore, the control unit can calculate the magnitude of the touch pressure by calculating the reduced amount of the mutual capacitance from a sensing signal obtained through the receiving electrode. So far, the case where the reference potential layer is the second side surface 1021′ and 1031′ has been described. When the reference potential layer is changed in accordance with the position of the attachment surface of the pressure detector 400, for example, even when the reference potential layer is positioned on the first side surface 1021 and 1031, the inner surface 1041′ or the outer surface 1041 of the side cover, the control unit calculate the magnitude of the touch pressure by obtaining the capacitance change amount according to the distance change between the reference potential layer and the pressure detector 400.

Also, the first pressure sensor 450 and the second pressure sensor 460 may be formed of a plurality of lozenge-shaped patterns in the same layer. Here, a plurality of the first pressure sensors 450 are connected to each other in a first axis direction and a plurality of the second pressure sensors 460 are connected to each other in a second axis direction. In at least one of the first pressure sensor 450 and the second pressure sensors 460, a plurality of respective lozenge-shaped electrodes are connected through a bridge, so that the first pressure sensor 450 and the second pressure sensor 460 may be insulated from each other. While the foregoing has shown that the touch pressure is detected from the change of the mutual capacitance between the first pressure sensor 450 and the second pressure sensor 460, only one of the first pressure sensor 450 and the second pressure sensor 460 may be included. In this case, the magnitude of the touch pressure can be detected by detecting the capacitance change between one pressure sensor (electrode) and a ground layer, that is, the self-capacitance change. Here, the drive signal and the receiving signal may be applied to one electrode and received.

Referring to FIG. 10d, the first pressure detector 400-1 and the second pressure detector 400-2 are disposed on the first side surfaces 1021 and 1031 and the second side surface 1021′ and 1031′ of the mounting space in the spacer layer, respectively. Here, the respective pressure detectors 400-1 and 400-2 are formed in the form of a sheet. After the first pressure sensor 450 or the second pressure sensor 460 is formed on the first insulation layer 470, the second insulation layer 471 may be formed and the first insulation layer 470 may be disposed on the first side surfaces 1021 and 1031 and the second side surfaces 1021′ and 1031′ of the mounting space, respectively.

When the pressure is applied to the side surface of the terminal through the object, the side frame of the terminal may be bent or pressed, and accordingly, the distance d between the first pressure detector 400-1 and the second pressure detector 400-2 is reduced. As the distance d is reduced, the receiving electrode can detect the increase amount of the mutual capacitance between the first pressure detector 400-1 and the second pressure detector 400-2. By using this, the magnitude of the touch pressure can be calculated.

The foregoing has described the method for detecting the magnitude of the pressure in the case where the pressure detector is disposed on the first side surface 1021 and 1031 of the mounting space and in the case where the first pressure detector 400-1 and the second pressure detector 400-2 are disposed on the first side surface 1021 and 1031 and the second side surface 1021′ and 1031′ of the mounting space, respectively. However, the method for detecting the magnitude of the pressure can be also applied in the same manner in the case where the pressure detector 400 is disposed only on the second side surface 1021′ and 1031′ of the mounting space, in the case where the touch detector 200 is further provided on the pressure detector 400 and in the case where the elastic foam is formed within the pressure detector 400 and thus the spacer layer (an example of the predetermined space S) is not provided.

Further, even when the side user input unit is formed on the side portion of the front case, the touch key may be formed in the same structure in the mounting space of the side portion of the front case.

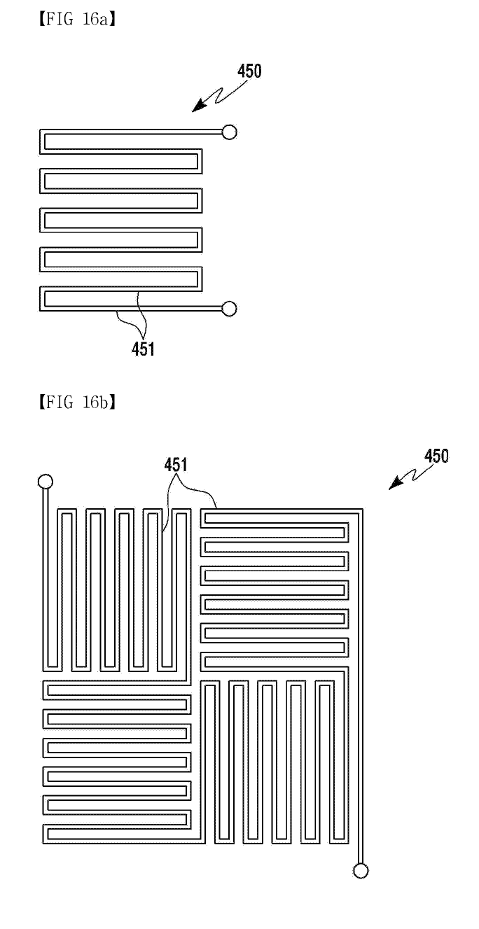

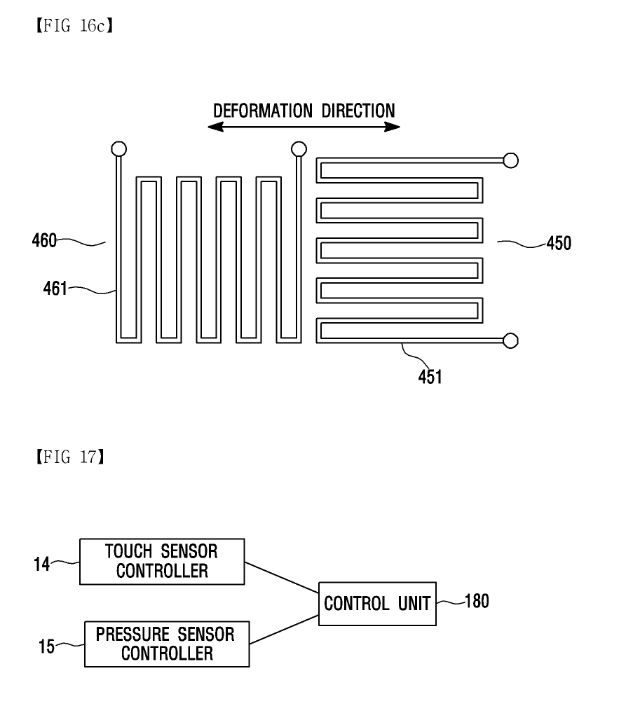

FIGS. 10a to 10d have described that the pressure sensors 450 and 460 included in the pressure detector are formed as electrodes and detect the capacitance change amount according to the bending of the side user input unit by the electrical characteristics sensed by the pressure detector, and thus, the magnitude of the pressure is detected. However, the present invention is not limited to this, and the pressure sensors 450 and 460 included in the pressure detector can calculate the magnitude of the touch pressure by using the electrical characteristic change (e.g., strain gauge, electrical resistance of Quantum Tunneling Composite (QTC)) other than the capacitance change amount. Specifically, in a case where a strain gauge is used, when a pressure is applied to the side surface of the terminal through the object in the vertical direction, a length change (L→L′) of the first pressure sensor 450 and the second pressure sensor 460 is detected and the magnitude of the pressure can be calculated by using the length change. In this case, a specific method thereof will be described with reference to FIGS. 16a to 16c. In addition, in the case of using the QTC, when a pressure is applied to the side surface of the terminal through the object in the vertical direction, the resistance value of the QTC material itself is changed by the pressure and the magnitude of the pressure can be calculated by measuring the change value.

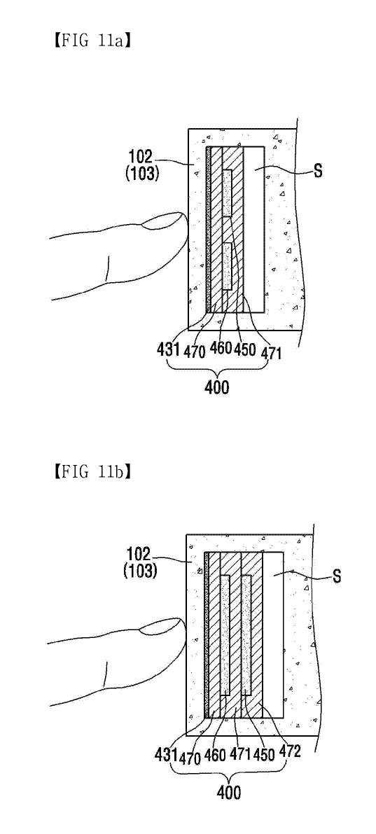

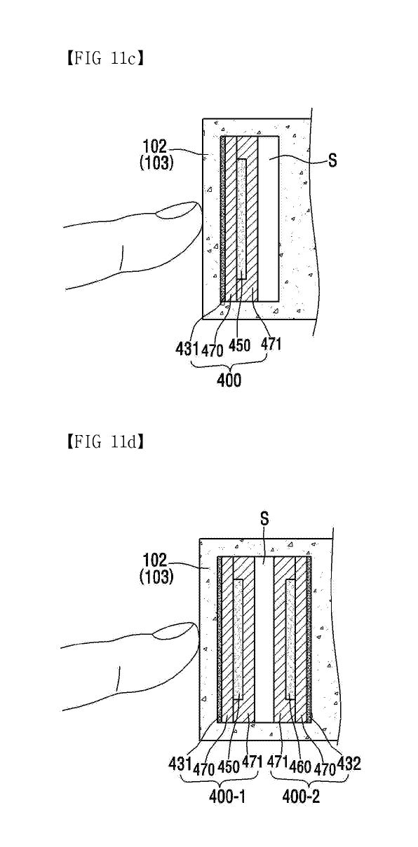

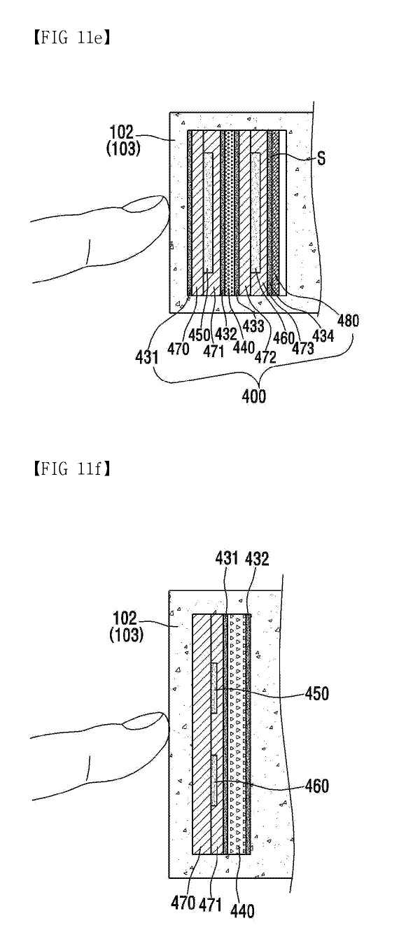

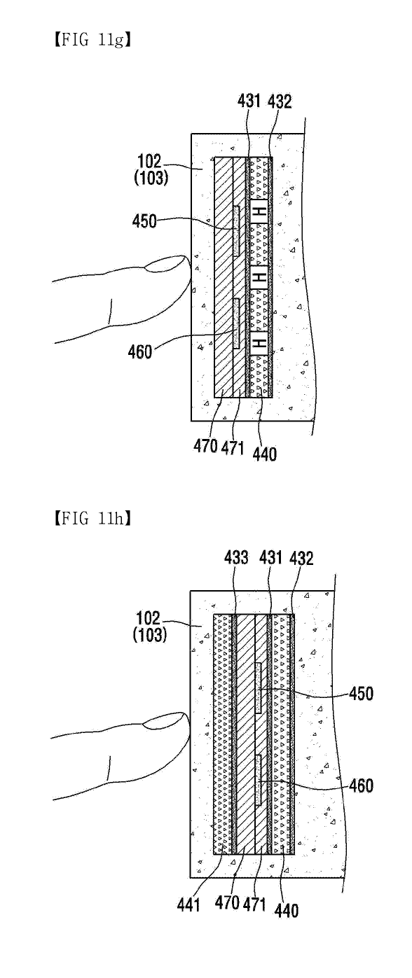

Hereinafter, FIGS. 11 to 15 are views for describing the structure of the pressure detector which detects the touch pressure by using the capacitance change amount. A case where the pressure sensor is formed as an electrode will be described.

FIGS. 11a to 11i are views for describing an exemplary structure of the pressure detector included in the portable terminal according to the embodiment of the present invention.

Referring to FIG. 11a, a cross sectional view shows that the pressure detector 400 including the first and second electrodes 450 and 460 is attached to the first side surface of the side portion mounting space through an adhesive layer 431 such that a predetermined space S is formed. Here, in the pressure detector 400, since the first and second electrodes 450 and 460 are positioned between the first insulation layer 470 and the second insulation layer 471, the first and second electrodes 450 and 460 can be prevented from being short-circuited with the mid-frame 102 or the rear cover 103. In addition, the mid-frame 102 or the rear cover 103 may not represent the ground potential or may represent a weak ground potential. In this case, the portable terminal according to the embodiment of the present invention may further include a ground electrode (not shown) between the mid-frame 102 or the rear cover 103 and the predetermined space S. Here, the ground electrode (not shown) can prevent the size of the capacitance generated between the first electrode 450 and the second electrode 460 which constitute the pressure detector 400 from increasing excessively. It is possible to consider that the first electrode 450 and the second electrode 460 are formed in different layers in accordance with the embodiment of the present invention so that the pressure detector 400 is formed.

Referring to FIG. 11b, a cross sectional view shows that the first electrode 450 and the second electrode 460 are formed in different layers. As shown in FIG. 11b, the first electrode 450 may be formed on the first insulation layer 470 and the second electrode 460 may be formed on the second insulation layer 471 positioned on the first electrode 450. According to the embodiment, the second electrode 460 may be covered with a third insulation layer 472. That is, the pressure detector 400 may include the first insulation layer 470 to the third insulation layer 472, the first electrode 450, and the second electrode 460. Here, since the first electrode 450 and the second electrode 460 are located in different layers, they are formed so as to overlap each other. For example, the first electrode 450 and the second electrode 460 may be formed similarly to the pattern of the drive electrode TX and the receiving electrode RX arranged in the M×N structure. Here, M and N may be natural numbers equal to or greater than 1. Alternatively, the first electrode 450 and the second electrode 460 of a particular type may be located in different layers, respectively.

Referring to FIG. 11c, a cross sectional view shows that the pressure detector 400 includes only the first electrode 450. As shown in FIG. 11c, the pressure detector 400 including the first electrode 450 may be disposed on the first side surface of the mounting space such that the predetermined space S is formed.

Referring to FIG. 11d, a cross sectional view shows that the first pressure detector sheet 400-1 including the first electrode 450 is attached to the first side surface of the mounting space, and the second pressure detector sheet 400-2 including the second electrode 460 is attached to the second side surface of the mounting space. Here, the predetermined space S is formed between the first pressure detector sheet 400-1 and the second pressure detector sheet 400-2, and the first pressure detector sheet 400-1 and the second pressure detector sheet 400-2 may be fixed to the first side surface and the second side surface through the first and second adhesive layers 431 and 432, respectively.

Further, even when the side user input unit is formed on the side portion of the front case, the touch key may be formed in the same structure in the mounting space of the side portion of the front case.

Referring to FIG. 11e, when the pressure detector 400 according to the embodiment of the present invention is attached to one side of the inner mounting space of the side portion by the first adhesive 431 and the touch pressure is applied perpendicular to the side surface of the terminal, the pressure detector 400 is pressed to detect a capacitance change amount. Here, a substrate 480 may be formed on the opposite side to the side of the pressure detector 400 to which the touch pressure is applied, that is, on the side which has not adhered to the mounting space. Also, in the pressure detector 400, the elastic foam 440 is positioned between the first electrode 450 and the second electrode 460, so that a distance between the first electrode 450 and the second electrode 460 may be caused to change by the pressure touch. Here, the second and third adhesives 432 and 433 may be further formed on both sides of the elastic foam 440 in order to attach the elastic foam 440. The substrate 480 can support the first and second electrodes 450 and 460, the first, second, third, and fourth insulation layers 470, 471, 472, and 473, and the elastic foam 440 which have been stacked on the substrate such that the thickness of the elastic foam 440 is changed by the applied pressure. The second electrode 460 may be a reference potential layer as a ground layer and the reference potential layer may be formed on the side surface of the mounting space to which the pressure detector 400 is not attached, that is, on the mid-frame 102 or the rear cover 103. When one side of the mid-frame 102 or the rear cover 103 is the reference potential layer, the pressure can be detected by the distance change of the predetermined space S between the pressure detector 400 and the one side of the mid frame 102 or the rear cover 103.

Referring to FIG. 11f, in the pressure detector 400 according to the embodiment of the present invention, the first and second electrodes 450 and 460 are positioned between the first insulation layer 470 and the second insulation layer 471. For example, after the first and second electrodes 450 and 460 are formed on the first insulation layer 470, the first and second electrodes 450 and 460 may be covered with the second insulation layer 471. Here, the first insulation layer 470 and the second insulation layer 471 may be made of an insulating material such as polyimide. The first insulation layer 470 may be made of polyethylene terephthalate (PET) and the second insulation layer 471 may be a cover layer made of ink. The first and second electrodes 450 and 460 may include a material such as copper or aluminum. According to the embodiment, the first insulation layer 470 and the second insulation layer 471 may be adhered together with each other by an adhesive (not shown) like a liquid adhesive, and the first and second electrodes 450 and 460 and the first insulation layer 470 may be adhered together with each other by an adhesive (not shown) like a liquid adhesive. Also, according to the embodiment, the first and second electrodes 450 and 460 may be formed by positioning a mask, which has a through-hole corresponding to a pressure electrode pattern, on the first insulation layer 470 and then by spraying a conductive material.

In FIG. 11f, the pressure detector 400 further includes the elastic foam 440, and the elastic foam 440 may be formed on one side of the second insulation layer 471 in such a manner as to be opposite to the first insulation layer 470. Later, when the pressure detector 400 is attached to the second side surface of the mounting space, the elastic foam 440 may be disposed on the second side surface side with respect to the second insulation layer 471.

Here, in order to attach the pressure detector 400 to the second side surface, the second adhesive layer 432 having a predetermined thickness may be formed on the outskirt of the elastic foam 440. According to the embodiment, the second adhesive layer 432 may be a double-sided adhesive tape. Also, the first adhesive layer 431 may also serve to adhere the elastic foam 440 to the second insulation layer 471. Here, the first and second adhesive layers 431 and 432 are disposed on the outskirt of the elastic foam 440, so that the thickness of the pressure detector 400 can be effectively reduced. The elastic foam 440 can perform an operation corresponding to the predetermined space S. For example, when the touch occurs on the top of the pressure detector 400, the elastic foam 440 is pressed and the distance between the first and second electrodes 450 and 460 and the reference potential layer (for example, the second side surface) is reduced. As a result, the mutual capacitance between the first electrode 450 and the second electrode 460 may be reduced. Through such a change of the capacitance, the magnitude of the touch pressure can be detected.

Referring to FIG. 11g, FIG. 11g shows a modified example of FIG. 11f. A hole “H” extending through the height of the elastic foam 440 is formed in the elastic foam 440, thereby causing the elastic foam 440 to be well pressed by the touch on the pressure detector 400. The hole “H” may be filled with air. When the elastic foam 440 is well pressed, the sensitivity for the pressure detection can be improved. Also, the hole “H” formed in the elastic foam 440 makes it possible to prevent the surface of the elastic foam 440 from being exposed due to the air at the time of attaching the pressure detector 400 to the second side surface, etc.

Referring to FIG. 11h, FIG. 11g shows a modified example of FIG. 11b. The first elastic foam 440 is included on one side of the second insulation layer 471 and a second elastic foam 441 is further included on one side of the first insulation layer 470. The first elastic foam 440 may be further formed in order to minimize the impact transmitted to the mid-frame side of the terminal when the pressure detector 400 is attached. Here, the third adhesive layer 433 for adhering the second elastic foam 441 to the first insulation layer 470 may be further included.

Referring to FIG. 11h, FIG. 11h shows the structure of the pressure detector 400 in which first group electrodes 450 and 451 and second group electrodes 460 and 461 are disposed to have the elastic foam 440 placed therebetween. The first group electrodes 450 and 451 are formed between the first insulation layer 470 and the second insulation layer 471, and the first adhesive layer 431, the elastic foam 440, and the second adhesive layer 432 may be formed. The second group electrodes 460 and 461 are formed between the third insulation layer 472 and the fourth insulation layer 473, and the fourth insulation layer 473 may be attached to one side of the elastic foam 440 by means of the second adhesive tape 432. Here, the third adhesive layer 433 may be formed on the substrate-side surface of the third insulation layer 472, and the pressure detector 400 may be attached to the second side surface of the side surface mounting space of the terminal through the third adhesive layer 433. The shown pressure detector 400 may not include the second insulation layer 471 and/or the fourth insulation layer 473. For example, the first adhesive layer 431 may not only function as a cover layer that directly covers the first group electrodes 450 and 451, but also function to attach the elastic foam 440 to the first insulation layer 470 and the first group electrodes 450 and 451. Also, the second adhesive layer 432 may not only function as a cover layer that directly covers the second group electrodes 460 and 461, but also function to attach the elastic foam 440 to the third insulation layer 472 and the second group electrodes 460 and 461.

Here, the elastic foam 440 is pressed by pressing the pressure detector 400, and thus, the mutual capacitance between the first group electrodes 450 and 451 and the second group electrodes 460 and 461 may increase. The touch pressure can be detected by the change of the capacitance. Also, according to the embodiment, one of the first group electrodes 450 and 451 and the second group electrodes 460 and 461 is maintained at the ground potential, and then the self-capacitance can be detected through the other one electrode.

In FIG. 11i, although the thickness and manufacturing cost of the pressure detector 400 are higher than those of a case where the electrode is formed as a single layer, it is ensured that a pressure detection performance is not changed according to the characteristics of the reference potential layer located outside the pressure detector 400. That is, the pressure detector 400 is formed as shown in FIG. 10d, so that an effect caused by an external potential (ground) environment can be minimized in the pressure detection.

In the pressure detector using the capacitance change amount according to embodiment of the present invention, the drive electrode and the receiving electrode are separated. The pressure can be detected by using the mutual capacitance change amount which changes as the drive electrode and the receiving electrode become close to the reference potential layer. The drive signal and the receiving signal are transmitted and received at one electrode, and the touch pressure can be detected based on self-capacitance change amount due to the distance change between the reference potential layer and the electrode. Specifically, when a pressure is applied by the touch, the reference potential layer or the pressure electrode (the drive electrode or the receiving electrode) moves, so that the distance between the reference potential layer and the pressure electrode is reduced and the value of the self-capacitance is increased. On the basis of the increased value of the self-capacitance, the touch pressure is detected by determining the magnitude of the touch pressure. When the touch pressure is not applied even by user's touch, the distance between the pressure electrode and the reference potential layer is not changed, so that the value of the self-capacitance is not changed. In this case, only the touch position by the touch detector 200 would be detected. However, when even the touch pressure is applied, the value of the mutual/self-capacitance is changed in the above manner, and the pressure detector 400 detects the touch pressure on the basis of the change amount of the self-capacitance.

Further, even when the side user input unit is formed on the side portion of the front case, the touch key may be formed in the same structure in the mounting space of the side portion of the front case, and the method for detecting the touch pressure may be applied in the same manner.

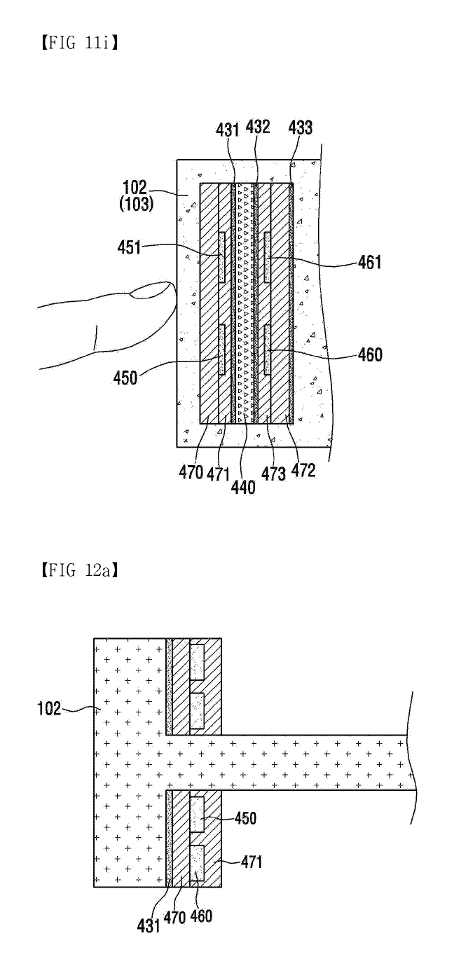

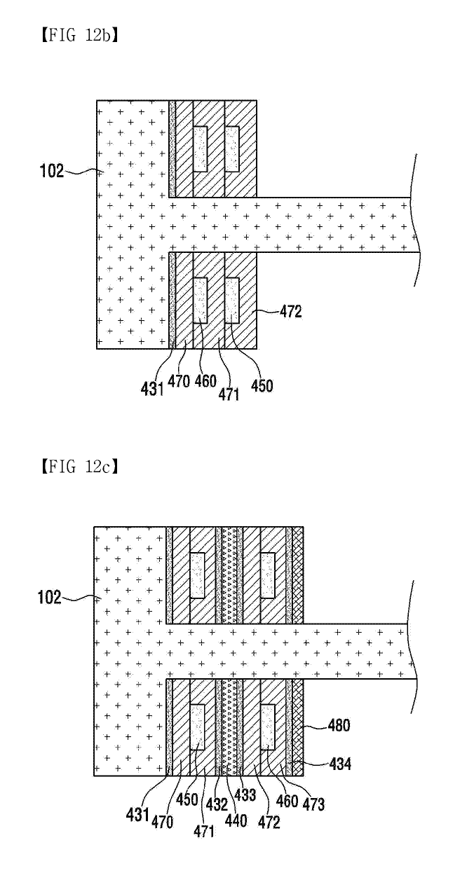

FIGS. 12a to 12c are views for describing another arrangement position and structure of the pressure detector included in the portable terminal according to the embodiment of the present invention.

Referring to 12a to 12c, the pressure detector 400 included in the portable terminal according to the embodiment of the present invention may be attached to the inner wall of the side portion of the mid-frame 102. Here, the pressure detector 400 may include one or more adhesive layers 431, 432 and 433, one or more insulation layers 470, 471 and 472, one or more electrodes 450 and 460, the elastic foam 440, and the substrate 480. When the inner wall of the side portion of the mid-frame 102 is formed symmetrically with respect to the center of the mid-frame 102, the pressure detector 400 may be attached to at least one of the upper inner wall and the lower inner wall of the center. Here, the pressure detector and the inner wall of the side portion of the mid-frame 102 may be adhered with each other by means of an adhesive, an adhesive tape, or the like.

Referring to FIG. 12a, in the pressure detector 400 attached to the inner wall of the side portion of the mid-frame 102, since the first and second electrodes 450 and 460 are positioned between the first insulation layer 470 and the second insulation layer 471, the mid-frame 102 and the first and second electrodes 450, 460 can be prevented from being short-circuited. The first and second electrodes 450 and 460 may be divided into the drive electrode and the receiving electrode, and may function as the drive electrode and the receiving electrodes, respectively. Since the first and second electrodes 450 and 460 are formed in the same layer, the distance change between the side portion of the mid-frame and the first and second electrodes 450 and 460 may be caused, due to the pressure applied perpendicular to the side portion of the mid-frame. A ground layer may be further formed on the side portion of the mid-frame, and the side portion of the mid-frame can function as the reference potential layer.

Referring to FIG. 12b, in the pressure detector 400 attached to the inner wall of the side portion of the mid-frame 102, the first electrode 450 and the second electrode 460 may be formed in different layers. As shown in FIG. 12b, the first electrode 450 may be formed on the first insulation layer 470 and the second electrode 460 may be formed on the second insulation layer 471 positioned on the first electrode 450. According to the embodiment, the second electrode 460 may be covered with the third insulation layer 472. That is, the pressure detector 400 may include the first insulation layer 470 to the third insulation layer 472, the first electrode 450, and the second electrode 460. Here, since the first electrode 450 and the second electrode 460 are located in different layers, they are formed so as to overlap each other. For example, the first electrode 450 and the second electrode 460 may be formed similarly to the pattern of the drive electrode TX and the receiving electrode RX arranged in the M×N structure. Here, M and N may be natural numbers equal to or greater than 1. Alternatively, the first electrode 450 and the second electrode 460 of a particular type may be located in different layers, respectively.

Referring to FIG. 12c, the pressure detector 400 attached to the inner wall of the side portion of the mid-frame 102 is attached to the inner wall of the side portion by means of the first adhesive 431, so that the touch pressure applied perpendicular to the side surface of the terminal can be detected. Here, the substrate 480 may be formed on the opposite side to the side of the pressure detector 400 to which the touch pressure is applied. Also, in the pressure detector 400, the elastic foam 440 is positioned between the first electrode 450 and the second electrode 460, so that a distance between the first electrode 450 and the second electrode 460 may be caused to change by the pressure touch. Here, the second and third adhesives 432 and 433 may be further formed on both sides of the elastic foam 440 in order to attach the elastic foam 440. The first and second electrodes 450 and 460 may be used as the drive electrode and the receiving electrode, respectively. In this case, the touch pressure can be detected by using the mutual capacitance change amount due to the distance change between the first electrode 450 and the second electrode 460. Also, the second electrode 460 may be the reference potential layer as a ground layer. The thickness of the elastic foam 440 between the first electrode 450 and the second electrode 460 is changed by applying the touch pressure, so that the capacitance change amount can be detected. The touch pressure can be detected by using the mutual/self-capacitance change amount. Also, the substrate 480 can support the first and second electrodes 450 and 460, the first, second, third, and fourth insulation layers 470, 471, 472, and 473, and the elastic foam 440 which have been stacked on the substrate such that the thickness of the elastic foam 440 is changed by the applied pressure. The second electrode 460 may be a reference potential layer as a ground layer.

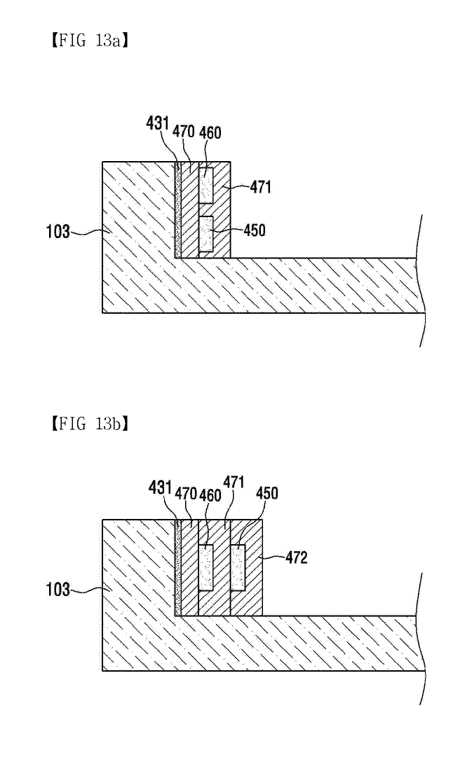

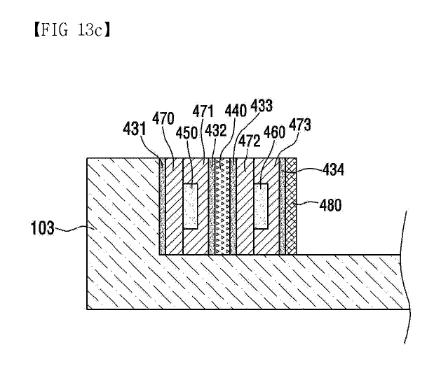

FIGS. 13a to 13c are views for describing further another arrangement position and structure of the pressure detector included in the portable terminal according to the embodiment of the present invention.

Referring to FIGS. 13a to 13c, the pressure detector 400 included in the portable terminal according to the embodiment of the present invention may be attached to the inner wall of the side portion of the rear cover 103. Here, the pressure detector 400 may include one or more adhesive layers 431, 432 and 433, one or more insulation layers 470, 471 and 472, one or more electrodes 450 and 460, the elastic foam 440, and the substrate 480. The structure and function of the pressure detector 400 attached to the inner wall of the side portion of the rear cover 103 are the same as those of FIGS. 12a to 12c described above.

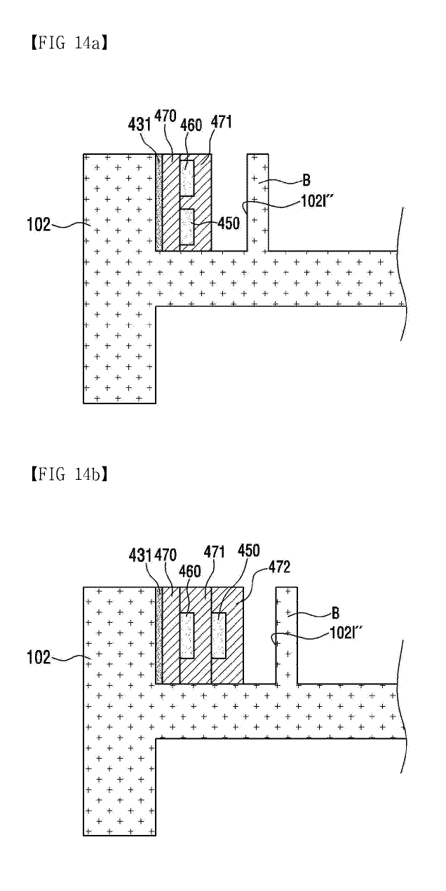

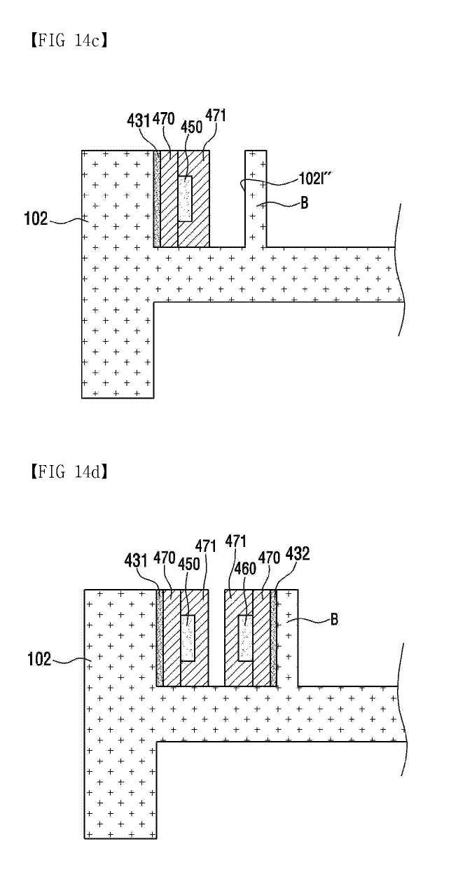

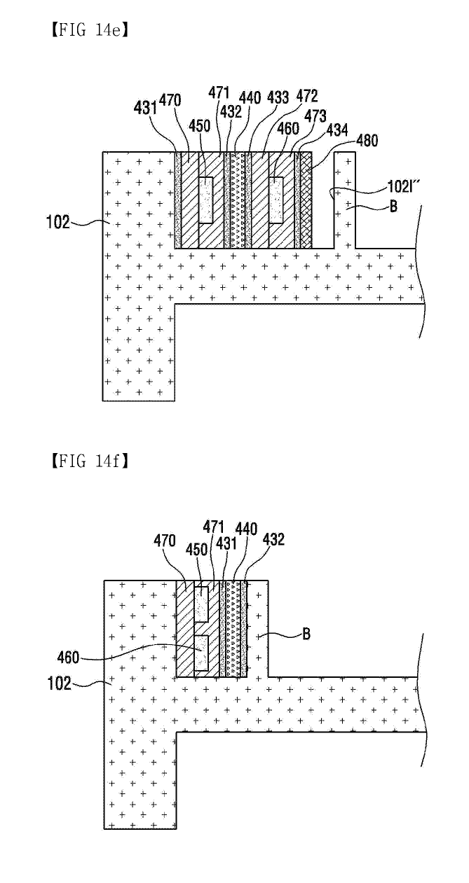

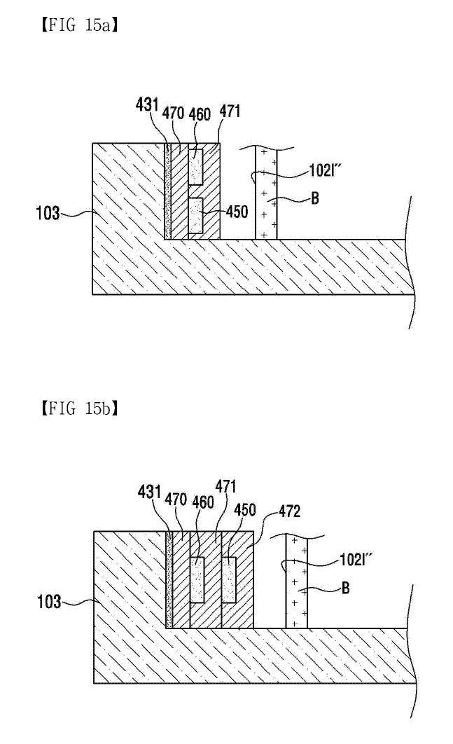

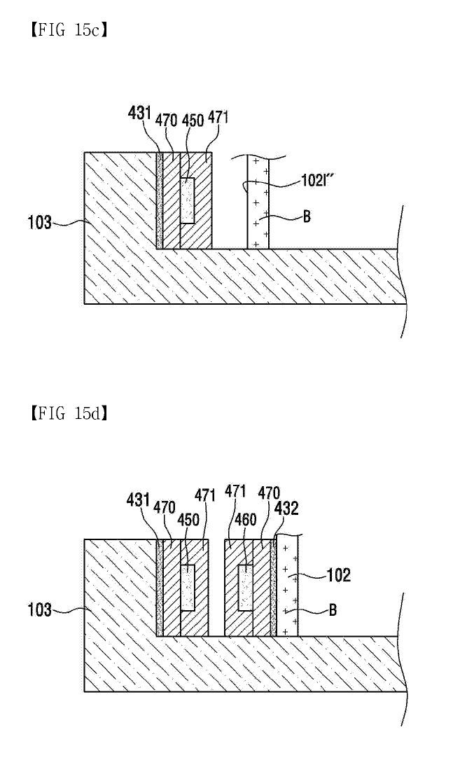

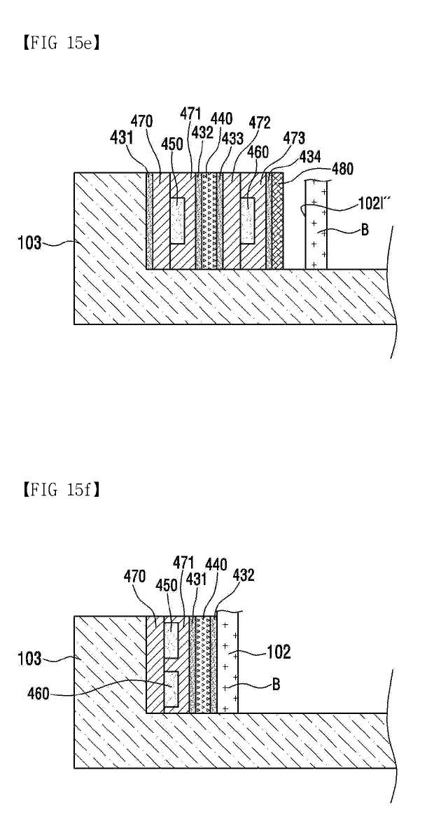

FIGS. 14a to 14f are views for describing a structure of the pressures detector which is included in the portable terminal according to the embodiment of the present invention and is attached to the inner wall of the side portion of the mid-frame where the partition wall B has been formed or is attached to the partition wall B. FIGS. 15a to 15f are views for describing a structure of the pressure detector which is included in the portable terminal according to the embodiment of the present invention and is attached to the inner wall of the side portion of the rear cover where the partition wall B has been formed or is attached to the partition wall B. Here, the partition wall B may be integrally formed with the mid-frame or the rear cover, and may be formed in the form of a separate partition wall B. When the pressure detector is attached to the partition wall B, the pressure detector may be attached to the partition wall B facing the side portion.

Referring to FIGS. 14a to 14f, the pressures detector which is included in the portable terminal according to the embodiment of the present invention and is attached to the inner wall of the side portion of the mid-frame where the partition wall B has been formed or is attached to the partition wall B may be formed in the same structure as that of FIGS. 11a to 11f, and only the reference potential layer can be replaced by the one surface 1021″ of the partition wall B.

Likewise, referring to FIGS. 15a to 15f, the pressures detector which is included in the portable terminal according to the embodiment of the present invention and is attached to the inner wall of the side portion of the rear cover where the partition wall B has been formed or is attached to the partition wall B may be formed in the same structure as that of FIGS. 11a to 11f, and only the reference potential layer can be replaced by the one surface 1021″ of the partition wall B.

Although only the case where the partition wall B is formed integrally with the mid-frame 102 in the embodiment is shown, the partition wall B can be integrally formed with the rear cover 103. In this case, the reference potential layer may be one surface of the partition wall B formed integrally with the rear cover.

FIGS. 16a to 16c are views showing that the pressure sensor according to the embodiment of the present invention is a strain gauge.

When the pressure sensor is the strain gauge 450, the touch pressure can be detected based on the resistance value change of the strain gauge according to the touch pressure. The electrical resistance of the strain gauge is changed in proportional to the amount of strain. Typically, a metal-bonded strain gauge may be used.

A transparent material used for the strain gauge may include conductive polymer (polyethylenedioxythiophene (PEDOT)), indium tin oxide (ITO), Antimony tin oxide (ATO), carbon nanotubes (CNT), graphene, gallium zinc oxide, indium gallium zinc oxide (IGZO), SnO₂, In₂O₃, ZnO, Ga₂O₃, CdO, other doped metal oxides, piezoresistive element, piezoresistive semiconductor materials, piezoresistive metal material, silver nanowire, platinum nanowire, nickel nanowire, other metallic nanowires, etc. An opaque material used for the strain gauge may include silver ink, copper, nano silver, carbon nanotube (CNT), Constantan alloy, Karma alloys, doped polycrystalline silicon, doped amorphous silicon, doped single crystal silicon, other doped semiconductor materials, etc.

As shown in FIG. 16a, the metal strain gauge may be composed of metal foils arranged in a grid-like manner. Through the grid-like manner, it is possible to maximize the deformation amount of a metal wire or foil which tends to be deformed in a parallel direction. Here, the vertical grid cross section of the strain gauge 450 may be minimized in order to reduce the effects of shear strain and Poisson strain. While the strain gauge 450 is at rest, that is to say, is not strained or deformed, the strain gauge 450 may include traces 451 which are disposed close to each other without contacting each other. The strain gauge may have a normal resistance such as 1.8KΩ±0.1% when it is strained or no force is applied. A sensitivity for the strain may be represented as a basic parameter of the strain gauge by a gauge factor (GF). Here, the gauge factor may be defined as a ratio of the change of the electrical resistance to the change of the length (strain) and may be represented as follows by a function of a strain ε.

$$GF = \frac{Δ R \text{/} R}{Δ L \text{/} L} = \frac{Δ R \text{/} R}{ɛ}$$

Here, ΔR represents the change amount of the strain gauge resistance, R represents a resistance of an undeformed strain gauge, and GF represents the gauge factor.

In the strain gauge 450 shown in FIG. 16a, the traces 451 are arranged in a horizontal direction. Therefore, the sensitivity for the horizontal deformation is high because the length change of the traces 451 is large with respect to the horizontal deformation. However, the sensitivity for the vertical deformation is low because the length change of the traces 451 is relatively small with respect to the vertical deformation.

Referring to FIG. 16b, the strain gauge 450 may include a plurality of sub-areas, and the arrangement direction of the traces 451 included in the respective sub-areas may be different. As such, the strain gauge 450 including the traces 451 of which the arrangement directions are different is provided, so that the sensitivity difference of the strain gauge 450 with respect to the deformation direction can be reduced.

Referring to FIG. 16c, the deformation directions of the traces 451 and 461 for the applied pressure may be changed according to the alignment directions of the strain gauges 450 and 460. Therefore, the strain gauges 450 and 460 may be arranged such that the longitudinal directions of the traces 451 and 461 are arranged according to the direction in which the pressure is applied.

Temperature increase can expand the frame even without the pressure applied, and thus, the strain gauge 450 may be extended. Therefore, the temperature change may have a bad influence on the strain gauge 450. As the temperature increases, the resistance of the strain gauge 450 increases, which may be incorrectly interpreted that a pressure is applied to the strain gauge 450. For the purpose of compensating for the temperature change, the effect of the temperature change can be minimized by using two gauges. For example, the strain gauge 450 is deformed in the horizontal direction, the traces 451 of the strain gauge 450 may be arranged in the horizontal direction parallel to the deformation direction, and the traces 461 of the dummy strain gauge 460 may be orthogonal to the deformation direction and may be arranged in a vertical direction. Here, the deformation affects the strain gauge 450 and hardly affects the dummy strain gauge 460. However, the temperature has the same effect on both the strain gauge 450 and the dummy strain gauge 460. Therefore, it is possible to remove the change due to the temperature and detect only the value due to the pressure change.

The portable terminal according to the embodiment of the present invention may include a pressure detector including a single channel by forming one strain gauge 450. In addition, the portable terminal according to the embodiment of the present invention may include a pressure detector including a plurality of channels by forming a plurality of strain gauges 450. By using the pressure detector including the plurality of channels, it is possible to simultaneously sense the respective magnitudes of a plurality of pressures of a plurality of touches.

Besides, at least one pressures detector may be formed of a piezoelectric element. When a certain solid material is subjected to mechanical stress (precisely, mechanical force or pressure) and a deformation occurs, polarization is generated within a certain solid and electric charge is accumulated (accumulate). When a particular solid material receives a mechanical stress (accurately, a mechanical force or pressure) and is deformed, polarization occurs within the solid material and electric charges are accumulated. The accumulated electric charges appear in the form of an electrical signal between both electrodes of the material, that is to say, voltage. This phenomenon is called piezoelectric effect, the solid material is called a piezoelectric material, and the accumulated charge is called piezoelectricity. At least one pressures detector can detect mechanical energy (force or pressure) applied to the piezoelectric element and electrical energy (voltage as a kind of an electrical signal) generated by the deformation due to the mechanical energy, and the control unit can calculate the applied mechanical force or pressure based on the detected voltage.

Also, at least one pressures detector may be implemented with MEMS pressure sensor. The MEMS pressure sensor can be fabricated through a back side through etching of a semiconductor substrate (frame of a side surface portion) in accordance with the pressure range used. The MEMS pressure sensor may be used as an absolute pressure sensor or a differential pressure sensor depending on whether a cavity is sealed or not. The MEMS pressure sensor may be divided into a piezoresistive type and a capacitance type according to a pressure detection method, and may be divided into a bulk type and a surface type according to a manufacturing method. A thin film is formed by a semiconductor process and a silicon piezoresistor is formed at the boundary between the thin film and the substrate. The piezoresistive type MEMS pressure sensor senses that the resistance of the piezoresistor is changed when the thin film is deformed by the pressure, thereby detecting the magnitude of the pressure. The capacitance type MEMS pressure sensor can measure the pressure magnitude by detecting the capacitance change amount between the electrodes when a gap between electrode plates facing each other is changed by an external force (stress). The bulk type MEMS pressure sensor can be fabricated by a method in which after a sensing circuit is configured on the front side of a silicon substrate, the substrate is penetrated through the back side thereof and processed, and then the upper part of the substrate is used as a sensing thin film. The surface type MEMS pressure sensor can be fabricated by a method for forming a sensing thin film and a pressure cavity on the surface of the substrate by a semiconductor process without directly processing the substrate.

As such, at least one pressures detector can be configured in various ways, and the present invention is not limited to the specific pressure sensing element, and any method capable of directly or indirectly calculating the pressure of the touch point can be applied to the present invention.

FIG. 17 shows a control block for controlling the touch position, the touch pressure, and the execution of functions corresponding thereto in the portable terminal according to the embodiment of the present invention. Here, the touch detector which detects whether or not the touch occurs and the touch position, or the pressure detector which detects the touch pressure may be formed in at least one area of the side surface of the terminal.

Referring to FIG. 17, the touch detector 200 and the pressure detector 400 may be provided with separate controllers 14 and 15 respectively and may transmit the detected touch position or touch pressure to the control unit 180. Alternatively, the touch detector 200 and the pressure detector 400 may simply transmit the detected signal (e.g., the self-capacitance, the mutual capacitance, and the change amount of the strain gauge, etc.) to the control unit 180. The control unit 180 may be an AP (application processor) or a central processing unit (CPU) of the portable terminal.

Specifically, the touch sensor controller 14 and the pressure sensor controller 15 may be formed of separate ICs, respectively, or may perform their respective functions together in one IC. That is, in the portable terminal including the touch sensor controller 14 and the pressure sensor controller 15, the touch sensor controller 14 may detect whether the touch occurs or not and the touch position, and the pressure sensor controller 15 may calculate the pressure magnitude and determine the pressure touch. Although the touch sensor controller 14 and the pressure sensor controller 15 are included in the portable terminal, the touch sensor controller 14 and the pressure sensor controller 15 simply transmit only the detected signal (e.g., the self-capacitance, the mutual capacitance, and the change amount of the strain gauge, etc.) to the control unit 180. The control unit 180 can detect whether the touch occurs or not and the touch position, calculate the pressure magnitude, determine the pressure touch, and execute functions corresponding thereto.

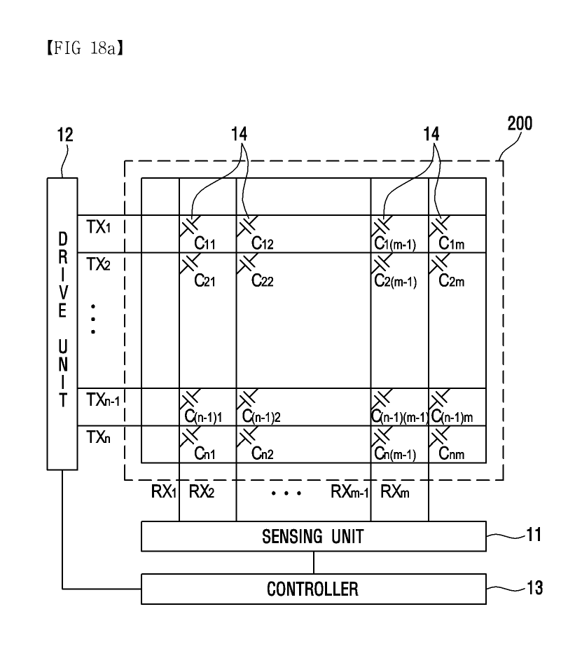

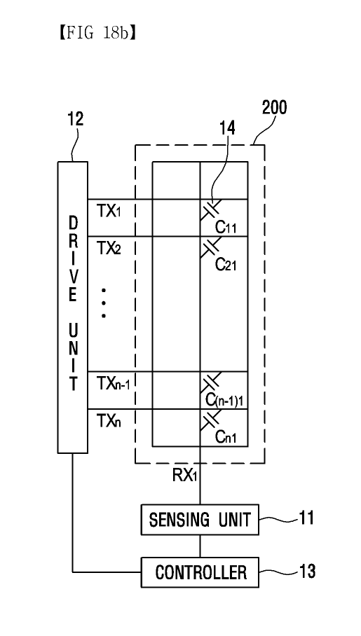

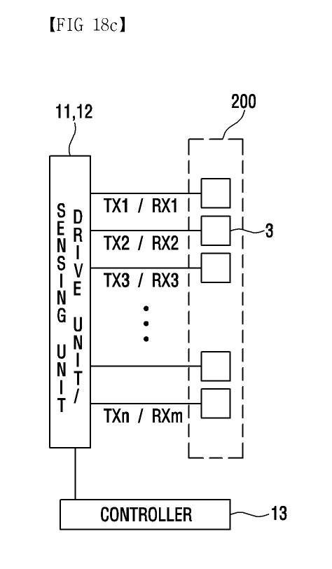

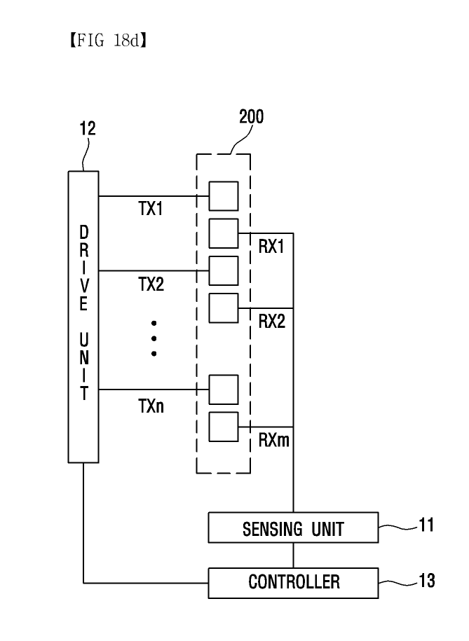

FIGS. 18a to 18d are schematic views showing the capacitive touch detector included in the portable terminal according to the embodiment of the present invention, and the configuration for the operation of the same.

Referring to FIG. 18a, the capacitive touch detector 200 included in the portable terminal according to the embodiment of the present invention may include a plurality of drive electrodes TX1 to TXn and a plurality of receiving electrodes RX1 to RXm. The touch detector 200 may be connected to a drive unit 12 which applies a drive signal to the plurality of the drive electrodes TX1 to TXn for the purpose of the operation of the touch detector 200, a sensing unit 11 which receives a sensing signal including information on a capacitance change amount changing according to the touch on a touch surface of the touch detector 200, and a controller 13 which applies a control signal to the drive unit 12 and detects whether or not the touch occurs and the touch position from the sensing signal received from the sensing unit 11. Here, the controller 13 may be one of the foregoing touch sensor controller 14 and the control unit 180.

The touch detector 200 may include the plurality of drive electrodes TX1 to TXn and the plurality of receiving electrodes RX1 to RXm. FIG. 18a shows that the plurality of drive electrodes TX1 to TXn and the plurality of receiving electrodes RX1 to RXm of the touch detector 200 form an orthogonal array.

The plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction. Here, when the drive electrodes TX are formed in a row direction, the receiving electrodes RX are formed in a column direction so as to cross the drive electrodes TX. Also, when the drive electrodes TX are formed in a column direction, the receiving electrodes RX are formed in a row direction so as to cross the drive electrodes TX.

The plurality of drive electrodes TX1 to TXn and the plurality of receiving electrodes RX1 to RXm may be formed in different layers. For example, one of the plurality of drive electrodes TX1 to TXn and the plurality of receiving electrodes RX1 to RXm may be formed on both surfaces of one insulation layer (not shown). Also, the plurality of drive electrodes TX1 to TXn may be formed on one surface of a first insulation layer (not shown), and the plurality of receiving electrodes RX1 to RXm may be formed on one surface of a second insulation layer (not shown) different from the first insulation layer.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh or may be composed of nano silver.

The drive unit 12 may apply a drive signal to the drive electrodes TX1 to TXn. One drive signal may be sequentially applied at a time to the first drive electrode TX1 to the n-th drive electrode TXn. The drive signal may be applied again repeatedly. This is only an example. The drive signal may be applied to the plurality of drive electrodes TX1 to TXn at the same time in accordance with the embodiment.

Through the receiving electrodes RX1 to RXm, the sensing unit 11 receives the sensing signal including information on a capacitance (Cnm) 14 generated between the receiving electrodes RX1 to RXm and the drive electrodes TX1 to TXn to which the driving signal has been applied. For example, the sensing signal may be a signal coupled by the capacitance (Cnm) 14 generated between the receiving electrode RX and the drive electrode TX to which the driving signal has been applied. As such, the process of sensing the driving signal applied from the first drive electrode TX1 to the n-th drive electrode TXn through the receiving electrodes RX1 to RXm can be referred to as a process of scanning the touch detector 200.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cnm) 14, and then converts the integrated current signal into voltage. The sensing unit 11 may further include an analog to digital converter (ADC) (not shown) which converts the integrated data by the receiver into digital data. Later, the digital data may be input to the controller 13 and processed to obtain information on the touch on the touch detector 200. The sensing unit 11 may include the ADC and the controller 13 as well as the receiver and may be integrally formed with them.

The controller 13 may perform a function of controlling the operations of the drive unit 12 and the sensing unit 11. For example, the controller 13 generates and transmits a drive control signal to the drive unit 12, so that the driving signal can be applied to a predetermined drive electrode TX1 at a predetermined time. Also, the controller 13 generates and transmits the drive control signal to the sensing unit 11, so that the sensing unit 11 may receive the sensing signal from the predetermined receiving electrode RX at a predetermined time and perform a predetermined function.

Referring to FIG. 18b, the touch detector 200 formed on the side surface of the portable terminal according to the embodiment of the present invention may be formed as one column in such a manner as to include the plurality of drive electrodes TX1 to TXn and one receiving electrode RX1. Alternatively, the touch detector 200 formed on the side surface of the portable terminal according to the embodiment of the present invention may include one drive electrode TX1 and the plurality of receiving electrodes RX1 to RXm.

When the touch detector 200 includes only the plurality of drive electrodes TX1 to TXn and one receiving electrode RX1, which drive electrode signal is applied to detect the touch position is determined only by a y-coordinate. Similarly, even when the touch detector 200 is comprised of one drive electrode TX1 and the plurality of receiving electrodes RX1 to RXm, which receiving electrode signal is received to detect the touch position is determined only by an x-coordinate.

In FIGS. 18a to 18b, the drive unit 12 and the sensing unit 11 may constitute a touch detection device (not shown) capable of detecting whether or not a touch occurs on the touch detector 200 according to the embodiment of the present invention and the touch position. The touch detection device according to the embodiment of the present invention may further include the controller 13. In the portable terminal including the touch detector 200, the touch detection device according to the embodiment of the present invention may be integrated and implemented on a touch sensing integrated circuit (IC), i.e., a touch sensing circuit. The drive electrode TX and the receiving electrode RX included in the touch detector 200 may be connected to the drive unit 12 and the sensing unit 11 included in the touch sensing IC (not shown) through, for example, a conductive trace and/or a conductive pattern printed on a circuit board, or the like. The touch sensing IC may be placed on a circuit board on which the conductive pattern has been printed, for example, a first printed circuit board (hereafter, referred to as a first PCB). According to the embodiment, the touch sensing IC may be mounted on a main board for operation of a touch input device.

As described above, a capacitance (Cnm) with a predetermined value is generated at each crossing of the drive electrode TX and the receiving electrode RX. When an object like a finger, palm, or stylus, etc., approaches close to the touch detector 200, the value of the capacitance may be changed. The capacitance may represent a mutual capacitance (Cnm). The sensing unit 11 senses such electrical characteristics, thereby being able to sense whether the touch has occurred on the touch detector 200 or not and where the touch has occurred. For example, the sensing unit 11 is able to sense whether the touch has occurred on the surface of the touch detector 200 comprised of a two-dimensional plane consisting of a first axis and a second axis.

More specifically, when the touch occurs on the touch detector 200, the drive electrode TX to which the driving signal has been applied is detected, so that the position of the second axial direction of the touch can be detected. Likewise, when the touch occurs on the touch detector 200, the capacitance change is detected from the reception signal received through the receiving electrode RX, so that the position of the first axial direction of the touch can be detected.

Referring to FIG. 18c, the touch detector 200 formed on the side surface of the portable terminal according to the embodiment of the present invention may be formed as a plurality of touch electrodes 3 formed as one layer. Here, the plurality of touch electrodes 3 may be arranged at a regular interval in the form of a grid, and wiring for transmitting and receiving the drive signal and the receiving signal may be individually connected to the respective touch electrodes 3.

The controller 13 transmits the drive control signal to the drive unit 12. On the basis of the drive control signal, the drive unit 12 applies the drive signal to a predetermined touch electrode 3 for a predetermined time. The controller 13 transmits a detection control signal to the sensing unit 11. On the basis of the detection control signal, the sensing unit 11 may receive the sensing signal from the predetermined touch electrode 3 for a predetermined time. Here, the sensing signal may be a signal for the change amount of the self-capacitance formed on the touch electrode 3. Whether the touch has occurred on the touch detector 200 or not and the touch position are detected by the sensing signal detected by the sensing unit 11. The controller 13 can detect the position of the touch of the object on the surface of the touch detector 200 by using a y-coordinate of the touch electrode 3.

Referring to FIG. 18d, the touch detector 200 formed on the side surface of the portable terminal according to the embodiment of the present invention may be formed as a plurality of touch electrodes formed as one layer. In the plurality of touch electrodes, the receiving electrode and the transmission electrodes may be alternately arranged. Here, the receiving electrodes and the transmission electrode may be disposed at a regular interval in the form of a grid. Wiring for transmitting and receiving the receiving signal may be connected to each receiving electrode, and wiring for transmitting and receiving the drive signal may be connected to each drive electrode.

The controller 13 transmits the drive control signal to the drive unit 12. On the basis of the drive control signal, the drive unit 12 applies the drive signal to a predetermined drive electrode for a predetermined time. The controller 13 transmits a detection control signal to the sensing unit 11. On the basis of the detection control signal, the sensing unit 11 may receive the sensing signal from the predetermined receiving electrode for a predetermined time. Here, the sensing signal may be a signal for the change amount of the mutual capacitance formed between the drive electrode and the receiving electrode. Whether the touch has occurred on the touch detector 200 or not and the touch position are detected by the sensing signal detected by the sensing unit 11. The controller 13 can detect the position of the touch of the object on the surface of the touch detector 200 by using y-coordinates of the drive electrode and the receiving electrode.

The touch detector 200 for detecting the touch position in the portable terminal according to the embodiment of the present invention may be located inside or outside a display module, or may be located inside or outside the side portion of the terminal.

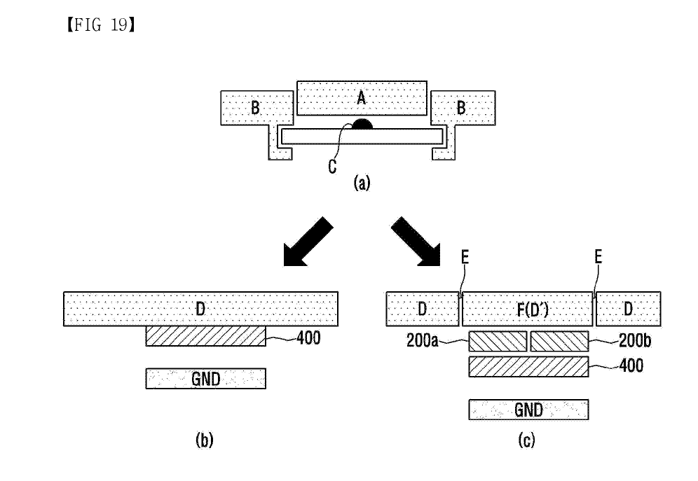

FIG. 19 is a view for describing the structure of the side portion of the portable terminal according to the embodiment of the present invention.

Referring to (a) of FIG. 19a, the side portion of the conventional portable terminal includes a physical operation key A made of a conductive or non-conductive material, a support portion B for supporting the physical operation key A, and a dome key (C) which is disposed under the physical operation key A and switches to be electrically connected to the frame. Here, the physical operation key A and the support portion B of the side portion may be formed of the same material, for example, a conductive material such as a metal. Also, the support portion B may be formed of a metal and the physical operation key A may be formed of a material having a different electrical property such as plastic.

Referring to (b) of FIG. 19, the side portion of the portable terminal according to the embodiment of the present invention is formed of a conductive material D such as a metal, and one or more pressure detectors 400 are disposed in at least some regions of the side portion respectively. Also, a ground layer (GND) may be disposed under each of the pressure detectors 400. In this case, the pressure magnitude can be detected by using the capacitance change amount according to the distance change between each pressure detector 400 and the ground layer.

Referring to (c) of FIG. 19, at least a portion of the side portion of the portable terminal according to the embodiment of the present invention may be formed of a non-conductive material or may be formed of a conductive material in a floating state.

Specifically, in the side portion of the portable terminal according to the embodiment of the present invention, only the side portion (i.e., a region where at least one of the touch detectors 200a and 200b and the pressure detector 400 is formed within the side portion) corresponding to the side user input unit may be formed of a non-conductive material F or a conductive material D′. Here, when the side portion is formed of the conductive material D′, the region formed of the conductive material D′ can be floating from the peripheral region by electrically isolating the side portion from adjacent regions. Here, the conductive material D′ can be electrically isolated from the adjacent regions (region formed of the conductive material D) by forming a gap E between the conductive material D′ and the adjacent region or by disposing a non-conductive material between the conductive material D′ and the adjacent conductive materials D. The conductive material D and D′ represents a metal material such as aluminum, magnesium alloy, a steel material, etc., and the non-conductive material F represents synthetic resins, glass fiber, rubber, etc.

At least one of the touch detector 200a and 200b is formed in one layer and detects whether or not the touch occurs or not and the touch position by using the self-capacitance change amount between the touch detector 200a and 200b and the ground layer. Alternatively, the first touch detector 200a is used as a drive electrode, and the second touch detector 200b is used as a receiving electrode, and the mutual capacitance change amount is used, so that whether or not the touch occurs or not and the touch position can be detected.

When the side user input unit where one or more touch detectors 200a and 200b have been stacked on the pressure detector 400 is formed of a conductive material, it may be difficult to distinguish whether the touch applied to the side user input unit is a general touch input or a pressure touch only by the capacitance change amount. The side portion corresponding to the side user input unit is distinguished from another side portion and is made of a non-conductive material, so that the reliability problem can be solved.

Therefore, according to the embodiment of the present invention, the side user input unit can be formed by using the pressure sensor or the touch sensor, and the type (general touch input or pressure touch) of the touch input to the side portion can be clearly distinguished.

What is claimed is:

1. A portable terminal comprising:
at least one pressure detector which is formed on a side thereof and detects a touch pressure; and
a control unit which controls to perform a function corresponding a predetermined condition, when the touch pressure detected by the at least one pressure detector satisfies the predetermined condition.

2. The portable terminal of claim 1, wherein the at least one pressure detector is formed in a mounting space of a side portion which extends from a mid-frame or a back cover of the portable terminal or the at least one pressure detector is formed on an inner surface of the side portion.

3. The portable terminal of claim 1, further comprising a haptic module, wherein the control unit outputs a haptic feedback through the haptic module when the predetermined condition is satisfied.

4. The portable terminal of claim 1, further comprising a touch detector which is disposed on or under the at least one pressure detector and detects whether the touch occurs or not and a touch input comprising a touch position.

5. The portable terminal of claim 4, wherein, when the control unit sets a function related to the at least one pressure detector to an inactive state and when the touch input is detected by the touch detector, the control unit changes the function related to the at least one pressure detector to an active state.

6. The portable terminal of claim 5, further comprising a haptic module, wherein the control unit outputs a haptic feedback through the haptic module when the function related to the at least one pressure detector is changed to the active state.

7. The portable terminal of claim 5, wherein, when the control unit changes the function related to the at least one pressure detector to the active state and does not receive the touch input during a set period of time, the control unit changes the function related to the at least one pressure detector to the inactive state again.

8. The portable terminal of claim 4, wherein, when the control unit sets a function related to the touch detector to the inactive state and the touch pressure detected through the at least one pressure detector satisfies a predetermined condition, the control unit changes the function related to the touch detector to the active state.

9. The portable terminal of claim 4, wherein the control unit sets the function corresponding to the predetermined condition by using at least one of a position at which the touch input is detected, a magnitude of the touch pressure, or a touch pressure pattern.

10. The portable terminal of claim 4, wherein, when the touch pressure is equal to or greater than a reference magnitude and a position where the touch input is detected is a first area among a plurality of side surface areas, the control unit performs a function of turning on or off the power of the terminal.

11. The portable terminal of claim 4, wherein, when the touch pressure is equal to or greater than a reference magnitude and a position where the touch input is detected is a second area among a plurality of side surface areas, the control unit performs a function of changing a mode of the terminal to a vibration mode or a normal mode.

12. The portable terminal of claim 4, wherein, when the touch pressure is equal to or greater than a reference magnitude and a position where the touch input is detected is a third area among a plurality of side surface areas, the control unit adjusts a sound volume in accordance with a pattern of the touch pressure.

13. The portable terminal of claim 1, wherein the at least one pressure detector further detects whether the touch occurs or not and a touch input including a touch position.

14. The portable terminal of claim 1, wherein a top surface of the at least one pressure detector is adhered to an inside of a side cover of the terminal.

15. The portable terminal of claim 1, wherein the at least one pressure detector detects the touch pressure by using at least one of a mutual capacitance, a self-capacitance, a strain gauge, a force sensing resistor, change of frequency, and change of thermal conductivity.

16. The portable terminal of claim 1, wherein the at least one pressure detector is composed of at least one of a pressure sensor formed as an electrode, a trace of a changing strain gauge, and a MEMS pressure sensor.

17. The portable terminal of claim 1, wherein an indicator corresponding to each area where the at least one pressure detector has been formed is displayed on the outside of the side portion of the terminal.

18. The portable terminal of claim 2, wherein at least a portion of the side portion where the at least one pressure detector has been formed is formed of a non-conductive material or is formed of a conductive material in a floating state.
